(19) United States
(12) Patent Application Publication
(10) Pub. No.: US 2019/0166944 A1
(43) Pub. Date: Jun. 6, 2019

(54) MECHANICAL SHOCK ABATEMENT SYSTEM INCORPORATING SACRIFICIAL SYSTEMS

(71) Applicant: Titon Corp., Guatemala City (GT)

(72) Inventors: Juan Francisco Javier Mini Townson, Guatemala City (GT); José Rodrigo Aragón Cabrera, Santa Catarina Pinula (GT); Juan Pablo Alfaro Samayoa, Guatemala City (GT); Johannes Kohler Mendizabal, San Jose Pinula (GT); Felix Armando Medrano Padilla, San Jose Pinula Guatemala (GT)

(73) Assignee: Titon Corp., Guatemala City (GT)

(21) Appl. No.: 16/021,646

(22) Filed: Jun. 28, 2018

Related U.S. Application Data
(60) Provisional application No. 62/595,580, filed on Dec. 6, 2017.

(51) Int. Cl. A42B 3/06; F16F 7/12; F16F 7/00; F16F 13/04; A42B 3/14; A42B 3/32; A42B 3/12

(52) U.S. Cl. CPC A42B 3/068; F16F 7/12; F16F 7/003; A42B 3/127; A42B 3/067; A42B 3/147; A42B 3/32; F16F 13/04

(57) ABSTRACT

Aspects of the subject disclosure may include, for example, a helmet suspension system including a number of levers, wherein a first lever of the number of levers rotates about a fulcrum in response to an impact force of a collision between a helmet shell and a foreign object to obtain a lever response. The system includes a sacrificial assembly including a first deformable member, wherein the sacrificial assembly is in communication with a group of levers of the number of levers. A first strain applied to the first deformable member according to the lever response to obtain a first stress response of the first deformable member based on a first stress-strain relationship including a non-linear response. The first stress response of the first deformable member includes the non-linear response, wherein the first stress response reduces a portion of the impact force transmitted to a body of a user. Other embodiments are disclosed.

### CROSS-REFERENCE TO RELATED APPLICATION(S)

This application claims priority to U.S. Provisional Application Ser. No. 62/595,580 filed on Dec. 6, 2017. The contents of the foregoing are hereby incorporated by reference into this application as if set forth herein in full.

### FIELD OF THE DISCLOSURE

Mechanical shock abatement system incorporating sacrificial systems.

### BACKGROUND

Safety helmets generally reduce effects of impacts to top and/or side of a user's head. Protective headgear often relies upon a hard outer casing with an impact-energy absorbing padding or a strap based suspension placed between the outer casing and the user's head. If a user wearing such hard shell helmet suffers a hard blow to the helmet, the impact of the hard shell meeting a hard surface generates a shockwave and a high impact force, that can be absorbed (to a limited extent) by the inner shock-absorbing material, or the straps in a typical suspension inside the hard casing and in contact with the user's head.

Various mechanisms responsible for brain injuries are understood to include focal type injuries that generally result from a direct impact to the head, sometimes resulting in cranial fracture. Other mechanisms include coup injuries that result from impacts to the same side of the head, whereas, contrecoup injuries result from impacts to an opposite side of the head. At least some injuries result from a displacement, e.g., a linear translation, of the brain within the skull. Still other injuries, including Diffuse Axonal Injuries (DAI), result from a rotational acceleration of the head and/or severe acceleration and/or deceleration that causes traumatic shearing forces, e.g., tissue sliding over tissue. DAI is believed to be one of the most common and devastating types of traumatic brain injury.

Some have disclosed protective helmets including a hard shell and an internal suspensions that include flexible cradle systems. For example, U.S. Pat. No. 2,870,445, to Fisher, discloses protective headgear and lining suspensions that include cradle straps joined together along an upper portion by an adjustment strap offering a flexible internal surface free of rigid projecting blow transmitting elements to cushion a head of a wearer. U.S. Pat. No. 3,054,111, to Hornickel et al., discloses a shock absorbing helmet that includes a head-receiving cradle formed from straps that may cross each other or be joined at their upper ends by a lace that makes the cradle adjustable. U.S. Pat. No. 2,921,318, to Voss et al. discloses a helmet lining that includes several flexible cradle straps extending up into a crown of a protective helmet from circumferentially spaced points around a lower portion. Each strap includes a strip of woven material that necks down as it stretches in reaction to a blow against the helmet. Other web-like support systems that include strips of flexible material that cross each other are disclosed in U.S. Pat. App. Pub. No. 2002/0000004 to Wise et al.

Others have disclosed protective helmets including a hard shell and external features to reduce head injury risk. For example, U.S. Pub. Pat. App. No. 2015/0157080, to Camarillo et al., U.S. Pub. Pat. App. No. 2011/0185481, to Nagely et al., and U.S. Pat. No. 5,581,816, to Davis, disclose wearable devices having force redirecting units connected between an outer surface of a helmet and a shoulder brace for redirecting head impact forces from a wearer's head to another body part. U.S. Pub. Pat. App. No. 2010/0229287, to Mothaffar, discloses an arrangement of straps extending from a helmet to other parts of a body to limit a range of motion of a wearer's head and flexure of their neck.

Still others have disclosed energy absorbing structures for placement along an interior surface of a helmet. For example, U.S. Pat. No. 9,316,282, to Harris, discloses energy absorbing, collapsible disk structures that have collapsible arms around a perimeter of two disks sandwiching that cause an elastic material to stretch, storing kinetic energy from a vertical direction as potential energy in a horizontal direction. U.S. Pat. No. 2,879,513, to Hornickel et al., discloses a crushable block of energy absorbing material disposed in each loop between a lace and an inner end of suspension cradle straps. Energy absorbed in crushing the blocks reduces the shock of an impact against a wearer's head. U.S. Pat. App. Pub. No. 2009/0260133, to Del Rosario, discloses an impact absorbing frame and multi-layered structure that includes inner opposite-facing inner panels that undergo elastic deformation and compress and expand to dissipate impact energy. U.S. Pat. No. 9,314,063, to Bologna et al., discloses a protective football helmet having a one-piece molded shell with an impact attenuation member formed by removing material from a front portion of the shell to form a cantilevered segment.

Although these and other conventional helmet liners have worked well, they have failed to provide protection against both high and low degrees of impact imparted on a helmet over the extended life of the helmet. The impact force is often so great that the user's helmet may even initially bounce back upon impact, thrusting the user's head away from the blow, subjecting the head and neck regions to additional injury causing forces. If the impact is severe enough, it may lead to a concussion (striking of the brain matter to the skull with moderate force) or worse. In some instances, a user can experience a, so called, focal type of injury, e.g., resulting from a lateral movement of head when the shell is impacted, alone or in combination with a rotation of the head, in which the head experiences a rapid acceleration and/or deceleration.

### BRIEF DESCRIPTION OF THE DRAWINGS

FIG. 1A depicts a side view of an example helmet-style shock abatement system;

FIGS. 1B-1D depict perspective, side and end schematic diagrams, respectively, of a lever-actuated helmet shock abatement system;

FIG. 2 depicts a schematic diagram of a pivot anchor of the lever-actuated helmet shock abatement system of FIGS. 1A-1D;

FIG. 3 depicts a schematic diagram of a lever of the lever-actuated helmet shock abatement system of FIGS. 1A-1D;

FIG. 4 depicts a schematic diagram of an example deformable member of the lever-actuated helmet shock abatement system of FIGS. 1A-1D;

FIG. 5 depicts a schematic diagram of an alternative embodiment of a lever-actuated helmet shock abatement system;

FIG. 6 depicts a schematic diagram of an example deformable member of the lever-actuated helmet shock abatement system of FIG. 5;

FIGS. 7A-7C depict side, end and perspective schematic diagrams, respectively of a lever portion of an example lever assembly of the lever-actuated helmet shock abatement system of FIG. 5;

FIGS. 8A-8C depict side, end and perspective schematic diagrams, respectively of a pivot anchor portion of the example lever assembly of the lever-actuated helmet shock abatement system of FIG. 5;

FIGS. 9A-9C depict side, end and perspective schematic diagrams, respectively of a lever portion of another example lever assembly of the lever-actuated helmet shock abatement system of FIG. 5;

FIGS. 10A-10C depict side, end and perspective schematic diagrams, respectively of a pivot anchor portion of the other example lever assembly of the lever-actuated helmet shock abatement system of FIG. 5;

FIGS. 11A-11D depict perspective, top, side and end views, respectively, of another example lever-actuated helmet shock abatement system;

FIGS. 12A-12D depict perspective, top, side and end views, respectively, of an example lever of the example of the lever-actuated helmet shock abatement system depicted in FIGS. 11A-11D;

FIG. 13 depicts a schematic view of a first detailed portion of the example lever depicted in FIGS. 12A-12D;

FIG. 14 depicts a schematic view of a second detailed portion of the example lever depicted in FIGS. 12A-12D;

FIG. 15A depicts an exploded view of the example lever-actuated helmet shock abatement system depicted in FIGS. 11A-11D;

FIG. 15B depicts a schematic view of a detailed portion of the example lever depicted in FIGS. 12A-12D and 15A;

FIG. 16 depicts a schematic view of another example lever assembly of the example lever-actuated helmet shock abatement system depicted in FIGS. 11A-11D;

FIGS. 17A-17B depict front and side views of an example helmet system including the lever-actuated shock abatement system depicted in FIGS. 11A through 15B;

FIG. 18 depicts a top cross-sectional view of an example helmet system including another embodiment of a lever-actuated shock abatement system;

FIG. 19 depicts a top cross-sectional view of another example helmet system including yet another embodiment of a lever-actuated shock abatement system;

FIG. 20 depicts a top cross-sectional view of yet another example helmet system including yet another embodiment of a lever-actuated shock abatement system;

FIGS. 21A-21B depict front and top views of another embodiment of a helmet assembly;

FIG. 22 depicts a top cross-sectional view of the helmet assembly depicted in FIGS. 21A-21B including an example lever-actuated shock abatement system;

FIG. 23 depicts a front cross-sectional view of an alternative embodiment of a lever-actuated shock abatement helmet system;

FIGS. 24A-24B depict side and perspective views of a pivot anchor assembly of the lever-actuated shock abatement helmet system depicted in FIG. 23;

FIG. 25 depicts a side view of yet another example lever-actuated shock abatement helmet system;

FIG. 26 depicts a schematic view of a detailed portion of the example lever-actuated shock abatement helmet system depicted in FIG. 25;

FIG. 27 depicts a front cross-sectional view of an alternative embodiment of a lever-actuated shock abatement helmet system;

FIG. 28 depicts a side view of a pivot anchor assembly of the lever-actuated shock abatement helmet system depicted in FIG. 27;

FIG. 29 depicts a perspective view of an example energy absorbing device (can be designed to absorb energy in the elastic region or plastic region up to the fracture point);

FIG. 30 depicts a perspective view of an example sacrificial member;

FIGS. 31A-31C depict perspective, top and side views, respectively, of another embodiment of a deformable member;

FIGS. 32A-32C depict top, sectional-isometric, and sectional views, respectively, of an embodiment of a composite deformable member;

FIGS. 33A-33C depict top, sectional-isometric, and sectional views, respectively, of another embodiment of a composite deformable member;

FIG. 34A depicts a top perspective view of a lever-actuated helmet shock abatement system during a first phase of operation;

FIG. 34B depicts a more detailed view of a top portion of the lever-actuated helmet shock abatement system of FIG. 34A;

FIG. 34C depicts a top perspective view of the lever-actuated helmet shock abatement system of FIG. 34A during a second phase of operation;

FIG. 34D depicts a more detailed view of a top portion of the lever-actuated helmet shock abatement system of FIG. 34C;

FIG. 34E depicts a top perspective view of the lever-actuated helmet shock abatement system of FIG. 34A during a third phase of operation;

FIG. 35A depicts an illustrative stress-strain curve of a material used in a lever-actuated helmet shock abatement system;

FIG. 35B depicts tabular information associated with a strain effect of a material used in a lever-actuated helmet shock abatement system;

FIG. 35C depicts tabular information associated with a time-temperature equivalence of a material used in a lever-actuated helmet shock abatement system;

FIG. 35D depicts tabular information associated with physical properties of a sample configuration of a material used in a lever-actuated helmet shock abatement system;

FIG. 36 depicts an example force-time curve of a relatively high stiffness material used in a lever-actuated helmet shock abatement system;

FIG. 37 depicts an example force-displacement curve of the relatively high stiffness material of FIG. 36;

FIG. 38 depicts an example force-time curve of a relatively low stiffness material used in a lever-actuated helmet shock abatement system;

FIG. 39 depicts an example force-displacement curve of the relatively low stiffness material of FIG. 38;

FIGS. 40A-40B depict top and side views of an embodiment of a breakable safety strip;

FIGS. 41A-41B depict side and sectional views, respectively, of an embodiment of an over-molded foam inclined plane of a lever actuated helmet shock abatement system;

FIGS. 42A-42B depict side and sectional views, respectively, of another embodiment of a lever of a lever actuated helmet shock abatement system adapted for disengagement;

FIGS. 43A-43C depict side, sectional and detail views, respectively, of yet another embodiment of a lever of a lever actuated helmet shock abatement system adapted for disengagement; and

FIG. 44A depicts a top view of a shape memory safety loop;

FIGS. 44B-44C depict side views of the safety loop of FIG. 44A according to first and second shapes.

### DETAILED DESCRIPTION

The subject disclosure describes, among other things, illustrative embodiments of devices and processes that abate impact shocks by enacting a machine that actuates a sacrificial system, member or device, sometimes referred to herein as a mechanical fuse, adapted to divert at least a portion of an impact force and/or energy away from a protected body through plastic deformation and/or fracture. Other embodiments are described in the subject disclosure.

One or more aspects of the subject disclosure include a safety device including a shock abatement assembly adapted for placement between a protective shell and a body of a user. The shock abatement assembly includes a number of levers and a number of fulcra that pivotally engage the number of levers. At least one lever of the number of levers rotates about a respective fulcrum of the number of fulcra in response to an impact force of a collision between the protective shell and a foreign object to obtain a lever response. The safety device further includes a sacrificial system including a first deformable member. The sacrificial system is in communication with a group of levers of the number of levers, wherein a first strain is applied to the first deformable member according to the lever response to obtain a first stress response of the first deformable member based on a first stress-strain relationship including a non-linear response. The first stress response of the first deformable member includes the non-linear response, wherein the first stress response reduces a portion of the impact force transmitted to the body of the user.

One or more aspects of the subject disclosure include a helmet suspension system including a number of levers, wherein a first lever of the number of levers rotates about a fulcrum in response to an impact force of a collision between a helmet shell and a foreign object to obtain a lever response. The system includes a sacrificial assembly including a first deformable member, wherein the sacrificial assembly is in communication with a group of levers of the number of levers. A first strain applied to the first deformable member according to the lever response to obtain a first stress response of the first deformable member based on a first stress-strain relationship including a non-linear response. The first stress response of the first deformable member includes the non-linear response, wherein the first stress response reduces a portion of the impact force transmitted to a body of a user.

One or more aspects of the subject disclosure include a process for collision protection. The process includes providing an impact protection assembly including a machine and a sacrificial assembly in communication with the machine. The sacrificial assembly includes a deformable member. An impact force is received according to a collision between a protective shell and a foreign object, wherein the impact protection assembly is configured for attachment to the protective shell to facilitate protection of a body of a user from the impact force. The machine is actuated in response to the impact force of the collision, and a strain is applied by the actuating of the machine, to the deformable member to obtain a stress response. The stress response is based on a stress-strain relationship including a non-linear response. The stress response of the deformable member includes the non-linear response, wherein the stress response reduces a portion of the impact force transmitted to the body of the user.

As used herein the term machine generally refers to one or more devices that transform energy and use and/or apply power to perform a particular task. A machine can include one or more parts, each with a definite function, that cooperate together and/or with other structures to perform the particular task. In general, machines can transmit and/or modify force and/or motion. The particular tasks can include, without limitation, a redistribution of a collision force, a redistribution of energy or both. The term machine includes one or more elementary mechanisms, such as a lever, a wheel and axle, a pulley, a screw, a wedge, and an inclined plane, generally referred to as simple machines. In at least some applications, the term machine can include complex machines, e.g., including a combination of one or more simple machines.

Machines can include, without limitation, devices that can be actuated, e.g., by applied energy and/or power. Actuation of the machine can set one or more parts or components of the machine into motion. The motion can include a controlled movement that can be controlled at least in part in a predetermined manner according to a structure of the machine. For example, controlled movement can allow parts to move in one direction while preventing the parts to move in another direction. Motion can include linear motion, rotational motion, and any combination thereof. In at least some embodiments, machines can include one or more elements that result in an irreversible transformation of at least a portion of energy applied to the machine.

A collision generally refers to a short-duration interaction between two or more bodies, resulting in a change in motion of the bodies involved due to internal forces acting between them. Collisions can be elastic, inelastic or some combination of both. All collisions conserve momentum. Elastic collisions conserve both momentum and kinetic energy; whereas, inelastic collisions conserve momentum, but not kinetic energy. A coefficient of restitution, e.g., ranging between 0 and 1, provides a measure of a degree to which a collision is elastic, “1”, or inelastic “0”.

A line of impact can be defined as a line drawn between centers of mass of two colliding bodies that passes through a contact point between the bodies. Collisions can be “head on” in which a velocity of each body just before impact is along the line of impact. Alternatively, collisions can be non-head on, also referred to as oblique collisions, e.g., glancing blows, in which the velocity of each body before the impact is not along the line of impact.

A magnitude of a relative velocity between two colliding bodies at a time of impact can be referred to as a closing speed. In a collision between two bodies, a change in motion of one of the bodies resulting from a collision with another one of the bodies depends on how the bodies collided, how long it took the bodies to stop or slow, across what distance the collision occurred, and a degree of deformity of one or both of the bodies.

Collisions also involve forces related to changes in velocities of the different colliding bodies. Namely, each body involved in a collision experiences a respective impact force. The collision causes a change in acceleration of each body resulting from the collision that occurs over a time interval of the collision. The impact force can be estimated or otherwise approximated as a product of the body's mass and the acceleration, e.g., a change in velocity with respect to time, resulting from the collision. In some instances the impact force can be represented as an average value, e.g., F=ma, in which the acceleration, a, is an average acceleration based on the collision. In general, it is understood that the acceleration can include one of a linear acceleration, a rotational acceleration, or both. Accelerations can be positive or negative. For example, a body at rest hit by another body, sometimes referred to as a foreign object, will experience an acceleration, whereas, a body moving that hits another body at rest will experience a deceleration.

Generally speaking, a foreign object includes any object capable of colliding with the example protective systems disclosed herein. Examples of foreign objects include, without limitation, any movable object, such as a vehicle, a body, a portion of a body, an article, goods, materials, merchandise, and the like, including other protective systems, e.g., other helmets. Alternatively or in addition, the foreign object can include immovable or substantially immovable objects, such as a building, a portion of a building, a wall, a floor, the ground, a tree, a guardrail, and the like. In some scenarios, one of the protective system or the foreign object is stationary just prior to a collision, whereas, the other one is moving. In other scenarios both the protective system and the object are moving, e.g., towards each other, away from each other, according to virtually any relative position, direction, speed, and/or acceleration that results in a collision between the protective system and the foreign object.

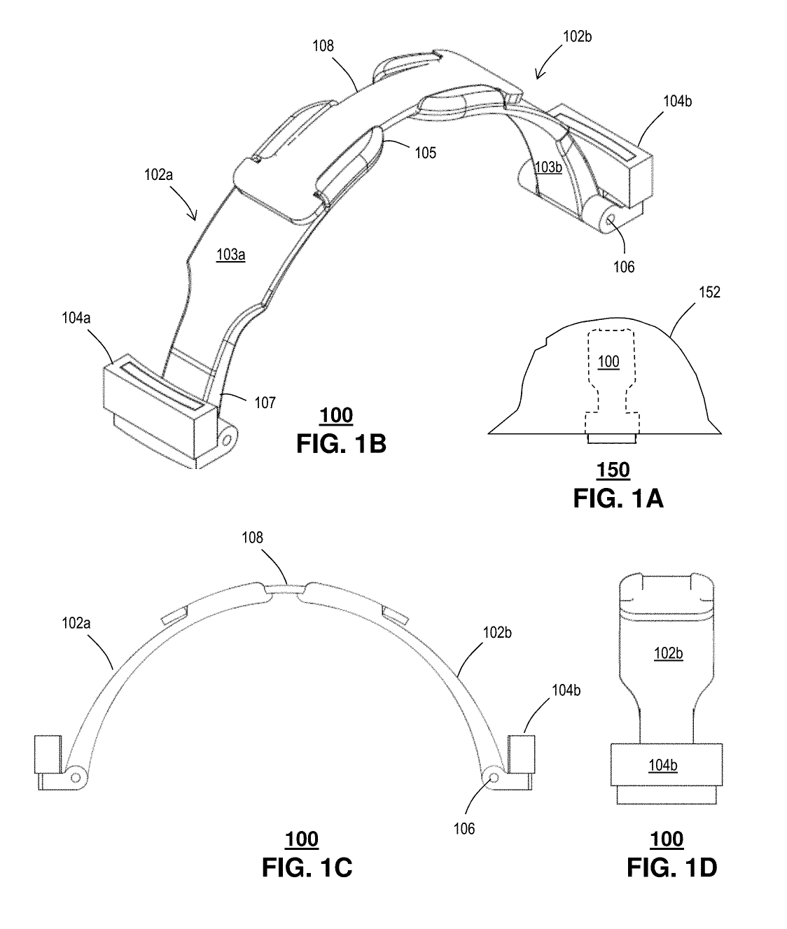

FIG. 1A depicts a side view of a helmet-style shock abatement system 150. The example shock abatement system 150 includes a helmet shell 152 and helmet suspension system 100. In at least some embodiments, the helmet suspension system 100 can include a lever assembly 100. The lever assembly 100 is disposed at least partially between the helmet shell 152 and a head and/or neck portion of a user.

The protective helmet shell 152 can be molded or otherwise formed from a material, such as a polymer, a composite, e.g., including a resin and a fibrous matrix, a metal, e.g., as used in armor, or any combinations thereof. In at least some embodiments, the helmet shell can be rigid. It is understood that the protective shell, e.g., the helmet, without limitation, can include a single layer of material or multiple layers of material and provides an external surface that is configured to receive a collision force. The multiple layers of material can be of the same or similar materials or different materials. For example, materials with a structural orientation, such as materials including fibers, e.g., woven materials, can be layered having different orientations.

The direction, number, and/or magnitude of an applied, e.g., collision, force depends upon an intended application for the helmet. In some instances, it is possible to generally categorize protective gear into at least four general categories, including those intended for: (i) single impact, single direction; (ii) single impact, multiple directions; (iii) multiple impacts, single direction, and (iv) multiple impacts, multiple directions. It should be understood that the shock abatement systems and protective techniques disclosed herein can be applied to one or more of these categories.

The lever assembly 100 includes a mechanism that facilitates mitigation of impact forces upon a user. For example, the mechanism can include a force-redirecting mechanism that, when placed between the protective shell and the human body, facilitates redirection of a portion of the collision force transferred to the human body.

The example machine 100 can redistribute an impact force of a collision, e.g., to one or more directions that differ from a line of impact of the collision. Alternatively or in addition, the machine 100 can expend at least a portion of kinetic energy associated with the impact to reduce a portion of collision energy transferred to the user's head. In at least some embodiments, the machine 100 introduces a delay between an instant of the collision and a time at which energy and/or force is transferred to the user's head. Such expenditures of energy and/or delays in response generally contribute to a reduction in acceleration and/or deceleration experienced by the user's head in response to the collision.

FIGS. 1B-1D depict perspective, side and end schematic diagrams, respectively, of an example lever assembly 100 portion usable with a helmet-style shock abatement system 150. The example lever assembly 100 includes a first lever 102a and a second lever 102b, generally 102. Each lever 102 includes an elongated support arm 103a, 103b extending between a first, e.g., top, end 105 and a second, e.g., bottom 107 end. Each lever 102 pivotally engages a respective fulcrum 106. In the illustrative example, the fulcrum 106 is located at a bottom end 107 of the lever 102. It is understood that in other embodiments, one or more of the fulcra 106 can be located at a position between opposing ends 105, 107 of the lever 102, such that each lever 102 rotates about its fulcrum 106. Alternatively or in addition, at least one of the fulcra 106 can be located at the top end 105 of the lever 102. Although the levers are illustrated with a generally vertical orientation, it is understood that the levers and/or pivots can be used alone or in combination with one or more other orientations, such as horizontal levers, angled levers, and so on.

The example lever assembly 100 also includes at least one deformable component 108. The example deformable component includes a resilient component, such as an elastomer, a spring, and the like, extending between the top ends 105 of the first and second levers 102a, 102b. The deformable member 108 is illustrated as being coupled between top ends 105. In operation, an outward rotation of the levers 102 causes the top ends 105 to separate, thereby deforming the deformable member 108. For example, outward rotation of the levers results in a stretching of the example elastomer 108.

The example lever assembly 100 further include a pivot anchor 104a, 104b, generally 104, disposed at bottom end 107 of each of the respective levers 102a, 102b. The pivot anchors 104 are adapted to anchor to a shell portion of the helmet.

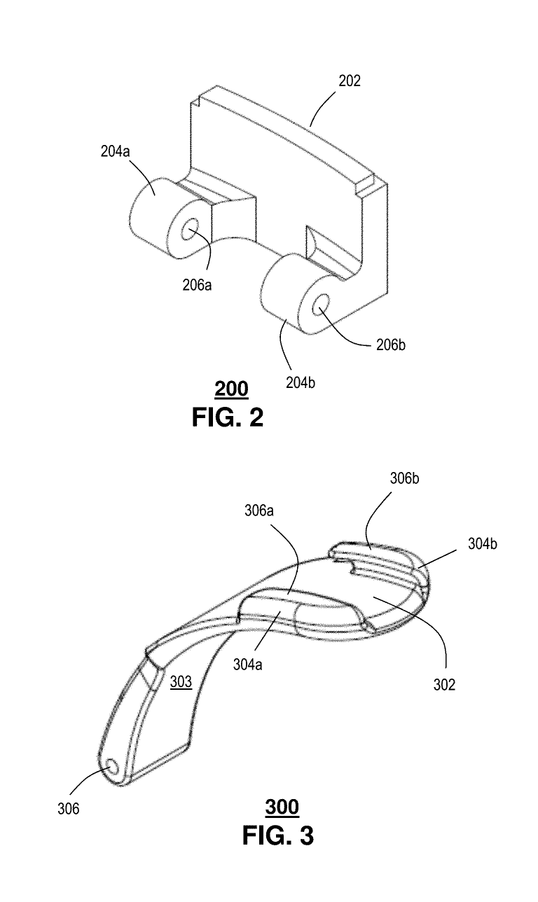

FIG. 2 depicts a schematic diagram of a pivot anchor 200 of the lever assembly 100 disclosed in FIGS. 1A-1D. The pivot anchor 200 includes a vertical member 202 extending between a bottom end portion and a top end portion. The pivot anchor 200 includes a pair of pivot extensions 204a, 204b, generally 204, extending outward and away from the bottom end portion. The pivot extensions 204 define pivot apertures 206a, 206b, generally 206. The pivot apertures are adapted to accept a pin and or axle about which the lever 102 may rotate.

FIG. 3 depicts a schematic diagram of a lever 300 of the lever-actuated helmet shock abatement system 100 (FIGS. 1A-C). The lever 300 includes an elongated member 303, including a pivot aperture 306 at one end and an anchor channel 302 at an opposite end adapted to retain one end of a deformable member 108 (FIGS. 1B-C). In the illustrative example, the elongated member 303 is shaped according to a curve adapted to conform to an adjacent portion of a user's head and/or neck, when worn. The example anchor channel 302 includes a pair of opposing wall segments 304a, 304b, generally 304, extending upward and away from a top portion of the elongated member 303. An open space, e.g., a separation distance between the opposing wall segments 304 is generally fixed to define side edges of the channel 302 together with an adjacent portion of the elongated member 303 disposed between the wall segments 304. In at least some embodiments, the opposing wall segments 304 include top retaining wall extensions 306a, 306b, generally 306, extending inward, towards each other and parallel to the top portion of the elongated member 303.

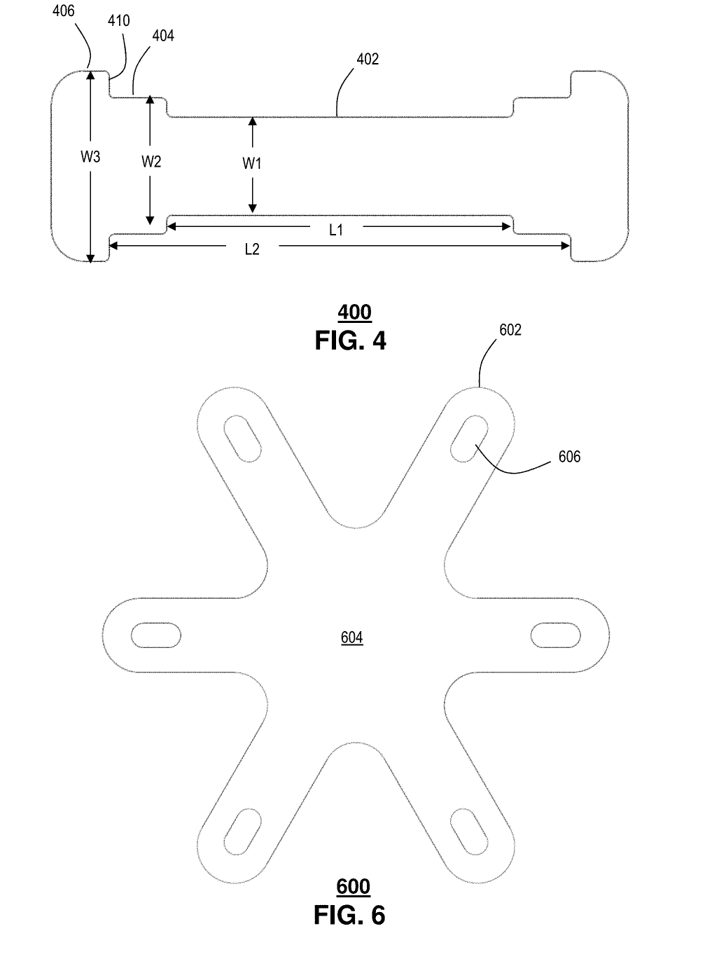

FIG. 4 depicts a schematic diagram of an example deformable member 400 of the lever-actuated helmet shock abatement system 100 (FIGS. 1A-D). The deformable member includes an elongated, rectangular mid-portion 402 extending for a first length L1 and having a first width W1. The deformable member 400 includes a second rectangular portion 404 at each of its opposing ends. The second rectangular portion extends over a limited length and has a second width W2 that may be greater than, equal to, or less than the first width W1. The second width W2 corresponds to the open space between the opposing wall segments 304, such that the top retaining wall extensions 306 overlap the second rectangular portion 404, retaining it in slideable engagement between the opposing wall segments 304. It is worth noting that the example deformable member 400 is planar, having a thickness, or depth “d” at least in proximity to outer edges of the second rectangular portion 404. The depth is selected to fit between the top portion of the elongated member 303 and the retaining wall extensions 306. In at least some embodiments, the deformable member 400 comprises a 3D configuration, e.g., having different thicknesses, shapes, cross sectional shapes apertures, extensions, and the like.

In at least some embodiments, the deformable member 400 includes opposing end portions 406. In the example embodiment, the opposing end portions include a third width W3, such that W3>W2. The differences in widths define a ridge 410 adapted to abut an end of the opposing wall segments 304, to provide interference to the slideable engagement, such that the opposing end portions 406 retain the deformable member 400 in frictional engagement between opposing levers 102 of the lever assembly 100 (FIGS. 1A-D). A second length L2 is defined between ridges of opposing end portions 406. In operation, the second width W2 and/or third width W3 is selected such that a separation of the levers 102, e.g., in response to their outward rotations about their respective pivots 106, facilitates a deformation, e.g., a stretching, of the deformable member 400. For example, the width W2 is adapted to fit within a grooves or channels of the opposing wall segments 304, and to abut against an end portion of the wall segments 304, e.g., where the grooves or channels terminate along a length of the wall segments 304. Alternatively or in addition, the width W3 is adapted to extend beyond a terminal portion of the wall segments 304. Accordingly, the deformable component 108 slideably engages the levers 102 by way of the channel 302 and/or wall segments 304 during construction and/or during periods of normal operation, i.e., not during a collision event. Beneficially, the deformable component 108 fixedly engages the levers 102 during a collision event through interference between the widths W2 and/or W3 and the channel 302 and/or wall segments 304.

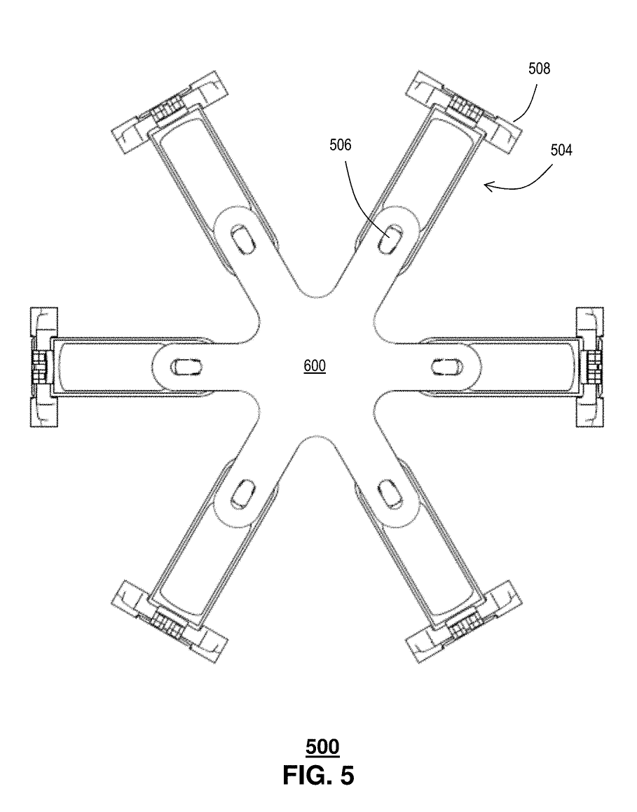

FIG. 5 depicts a schematic diagram of an alternative embodiment of a lever-assembly 500, e.g., for use in a helmet-style shock abatement system. The lever-assembly 500 includes six levers 504 and a deformable member 600. Each lever includes a deformable member anchor 506 and a pivot anchor 508. The deformable member anchor 506 is adapted to retain an adjacent portion of the deformable member 600 (FIG. 6). The pivot anchor 508 is adapted to attach to a support structure, such as a support frame and/or to a helmet shell. The pivot anchor 508 provides a pivotal engagement to the lever 504, allowing the lever 504 to rotate about the pivot. Rotations of one or more of the levers 504 exerts a force(s) upon the deformable member 600, causing a deformation of the deformable member 600.

FIG. 6 depicts a schematic diagram of an example deformable member 600 of the lever-actuated helmet shock abatement system of FIG. 5. The deformable member 600 includes six extension arms 602 disposed about a central section 604. Each of the extension arms 602 includes an anchoring portion, such as the example aperture 606.

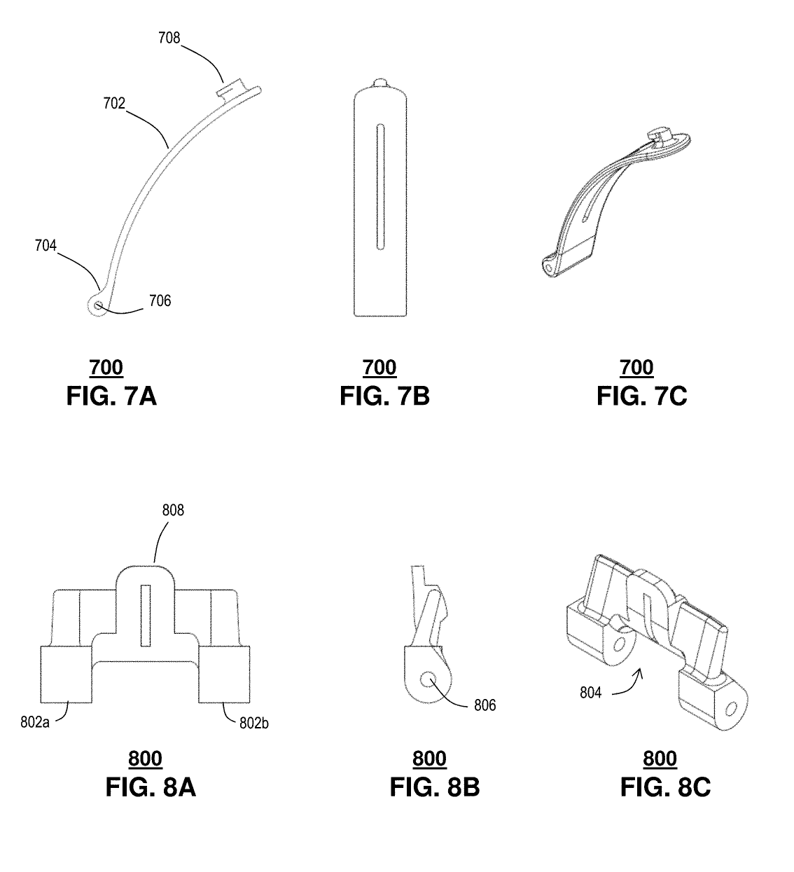

FIGS. 7A-7C depict side, end and perspective schematic diagrams, respectively of an example lever 700 of a lever assembly of an embodiment of the lever assembly 500 (FIG. 5). The lever includes an elongated member 702 having an anchor 708 at an upper end and a pivot aperture 706 at a lower end 704.

FIGS. 8A-8C depict side, end and perspective schematic diagrams, respectively of an example pivot anchor 800 of the lever assembly of the example embodiment of the lever assembly 500 (FIG. 5). The pivot anchor 800 includes a rigid member 808 having two pivot extensions 802a, 802b, generally 802. The example pivot extensions 802 define apertures 806 adapted to retain an axle and/or pin to facilitate pivoting of the lever 700 about the pivot point. In the illustrative example, the pivot extensions 802 are spaced apart to define an open space 804 therebetween. The open space is configured to accept the lower end 706 of the lever 700.

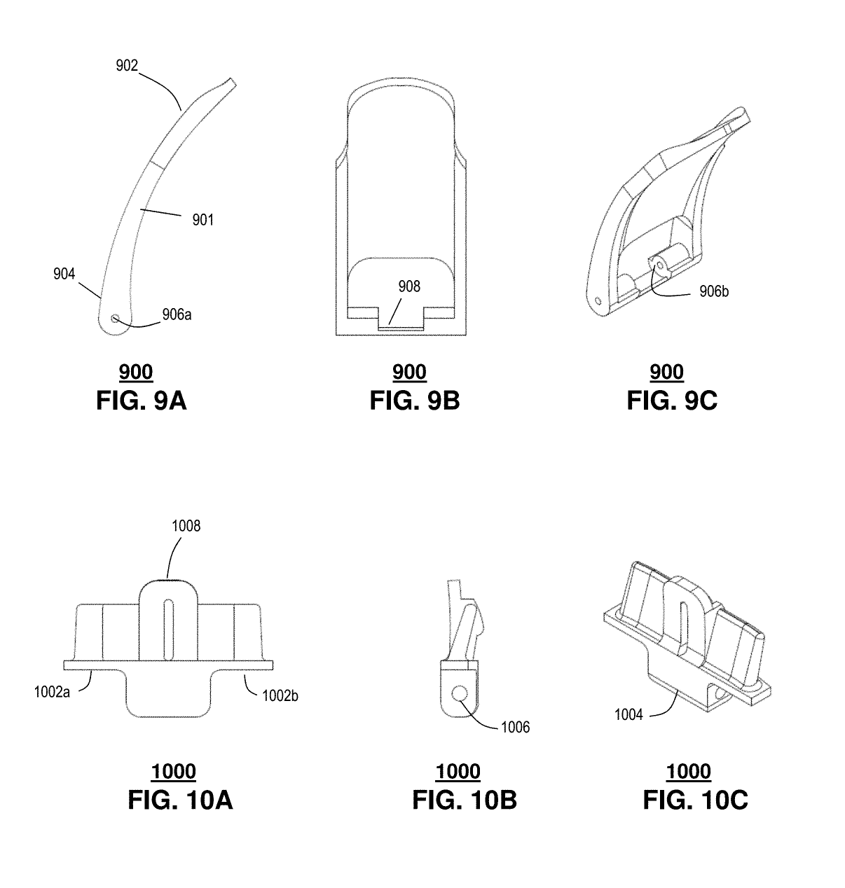

FIGS. 9A-9C depict side, end and perspective schematic diagrams, respectively of an example lever 900 of a lever assembly of an embodiment of a lever assembly. The lever includes an elongated member 901 extending between an upper end 902 and a lower end 904. The lower end 904 defines two pivot apertures 906a, 906b, generally 906. The lower end 904 also defines a notch 908 between the pivot apertures 906.

FIGS. 10A-10C depict side, end and perspective schematic diagrams, respectively of another example of a pivot anchor 1000 of the lever assembly. The pivot anchor 1000 includes a rigid member 1008 having a pivot extension 1004. Opposing ends of the pivot extension 1004 and adjacent lower portions of the rigid member 1008 define recessed areas 1002a, 1002b, generally 1002. The example pivot extension 1004 defines an apertures 1006 adapted to retain an axle and/or pin to facilitate pivoting of the lever 900 about the pivot point. In the illustrative example, the pivot extension 1004 is adapted to fit within the notch 908, allowing the notch 908 of the lever 900 to accept the pivot extension 1004.

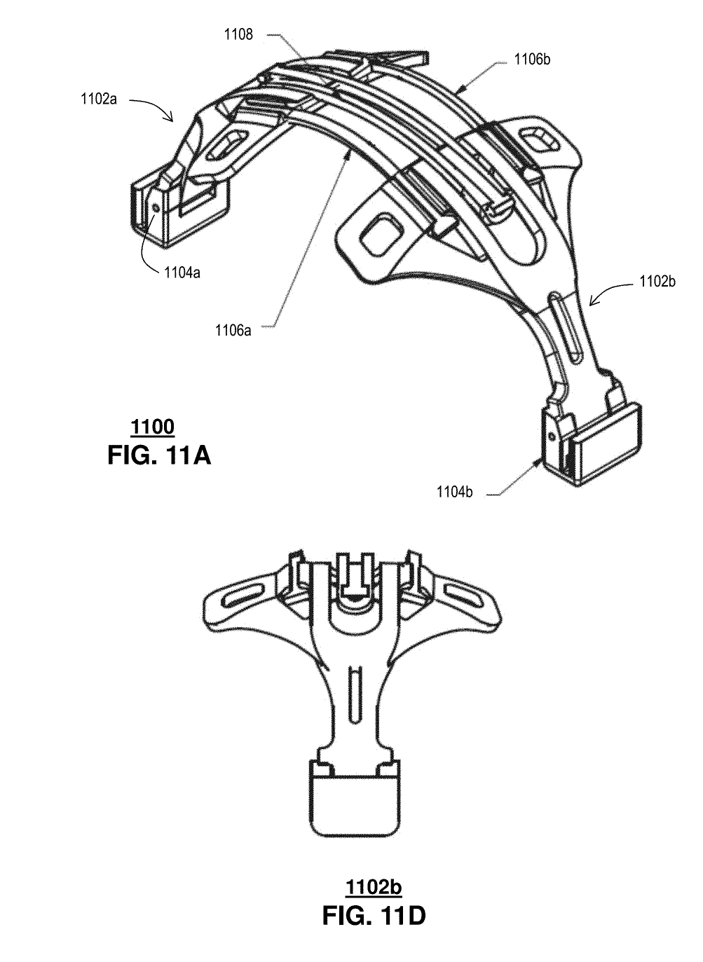

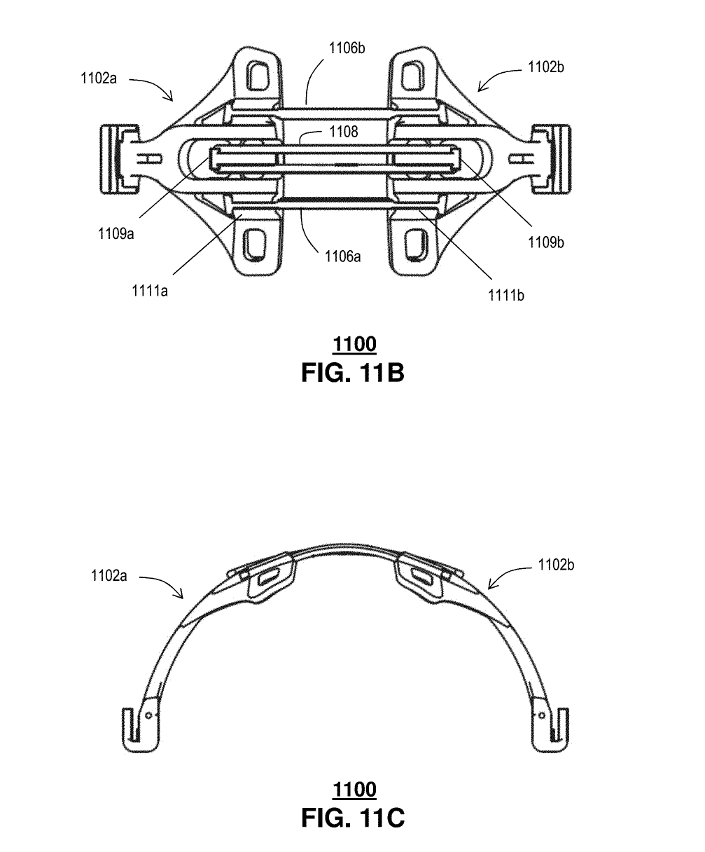

FIGS. 11A-11D depict perspective, top, side and end views, respectively, of another example lever assembly 1100 for use in a lever-actuated helmet shock abatement system, e.g., placed within a helmet shell 152 (FIG. 1A). The lever assembly 1100 includes a pair of opposing levers 1102a, 1102b, generally 1102. The assembly 1100 also includes a pair of pivotal anchors 1104a, 1104b, generally 1104. Each of the pivot anchors 1104 pivotally engages a lower end of a respective lever 1102, to allow a pivoting of the lever 1102 about its respective pivot anchor 1104. As will be discussed further hereinbelow, the pivot anchors 1104 are adapted for secure attachment to a frame assembly and/or directly to a helmet shell 152. As in preceding examples, the levers 1102 are shaped, e.g., having a curve, and in some instances a compound curve, to conform to an adjacent portion of a user's head and/or neck, when worn.

The lever assembly 1100 includes at least one deformable member extending between the opposing levers 1102, and adapted to deform in response to forces exerted upon the deformable member(s) in response to the pivoting action of the levers 1102. For example, an outward rotation of the levers 1102 results in an increased separation between top ends of the opposing levers 1102. The increasing separation can induce a force upon the deformable member(s), such as tension, a compression, a bending and/or twisting.

The illustrative embodiment 1100 includes multiple deformable members. Namely, a first deformable member includes an elastomer 1108. The elastomer 1108 is formed in a loop, e.g., according to an O-ring, and/or an elastic or rubber band. The elastomer 1108 is held in place between the levers 1102 by a pair of anchors 1109a, 1109b, generally 1109. Separation of the levers 1102 results in separation of the pair of anchors 1109, which, in turn, stretches the elastomer 1108.

The illustrative embodiment 1100 further includes a pair of deformable sacrificial members 1106a, 1106b, generally 1106. The sacrificial members 1106 are formed as elongated straight segments including enlarged end portions. The sacrificial members 1106 are held in place between the levers 1102 by pairs of mounting slots 1111a, 1111b, generally 1111. Separation of the levers 1102 results in separation of opposing mounting slots 1111, which, in turn, stretches the sacrificial members 1106. The enlarged end portions generally prevent the sacrificial members 1106 from sliding completely through their respective mounting slots 1111.

In at least some embodiments, the sacrificial members 1106 are adapted to plastically deform in response to separation of the levers, up to and including a point of fracture or failure. Failure can include a fracturing and/or severing of the sacrificial member 1106. In at least some embodiments, the plastic deformation and/or mechanical failure can occur at any point along the sacrificial member. By way of example, a location of a point of plastic deformation and/or failure along a sacrificial member 1106 can be controlled by physical properties of the sacrificial member. Such physical properties can include, without limitation, cross section shapes, cross sectional dimensions, material choice, material density, a presence of apertures or holes, e.g., to concentrate stresses, and the like. In at least some embodiments, the mechanical failure can include failure of the enlarged ends portions and/or failure of the mounting slots 1111.

Although the sacrificial members 1106 are disclosed as elongated straight segments extending between two or more levers 1102, it is understood that the sacrificial members can include other shapes, such as one or more of bent structures, segmented structures, curved structures, solid structures, enclosed structures, e.g., loops, and so on. Alternatively or in addition, it is understood that the sacrificial members 1106 can include other structures, such as anchors or hooks used to retain the deformable members 1106. For example, the hooks can be adapted to plastically deform up to and including a point of fracture in response to strains resulting from a collision, before the deformable members 1106 plastically deform and/or fracture.

In operation, at least some separation of the levers may be allowed without inducing a plastic deformation of the sacrificial members 1106, e.g., allowing the sacrificial members 1106 to slide through their respective mounting slots 1111, without engaging the enlarged end portions. At a separation beyond a first separation threshold, however, the sacrificial members 1106 experience plastic deformation. The plastic deformation can continue up to a second separation threshold, greater than the first, at which point one or more of the sacrificial members 1106 fails. Despite failure of the sacrificial members, the elastomer 1108 remains operable beyond the second separation threshold. It is understood that one or more of plastic deformation and/or failure of the sacrificial member(s) 1106 and/or stretching of the elastomer 1108 transfer kinetic energy of a collision into other forms of energy, thereby reducing another portion of the kinetic energy of the collision to a user of the helmet-style shock-abatement system.

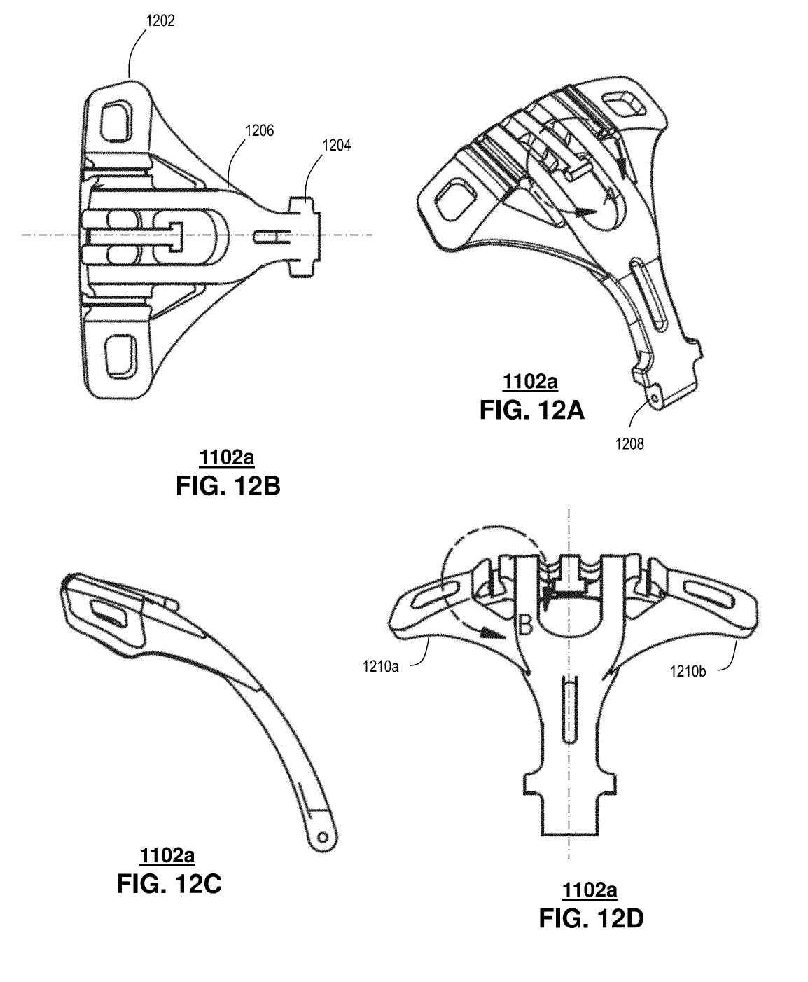

FIGS. 12A-12D depict perspective, top, side and end views, respectively, of an example lever 1200 of the example of the lever-assembly 1100 depicted in FIG. 11-D. The lever 1200 includes a top end 1202, a bottom end 1204 and a mid-section 1206 extending therebetween. The top end 1202 can include lateral extensions 1210a, 1210b, generally 1210, that extend outward and away from a center line of the lever. The lateral extensions can be sized and/or shaped to facilitate a comfortable, secure and safe fit to adjacent portions of a user's head and/or neck, when worn. In the illustrative example, the lateral extensions 1210 are curved to conform to the head. In at least some embodiments, the lateral extensions 1210 alone or in combination with the mid-section 1206 facilitate distribution of impact forces over relatively large regions of a user's head and/or neck

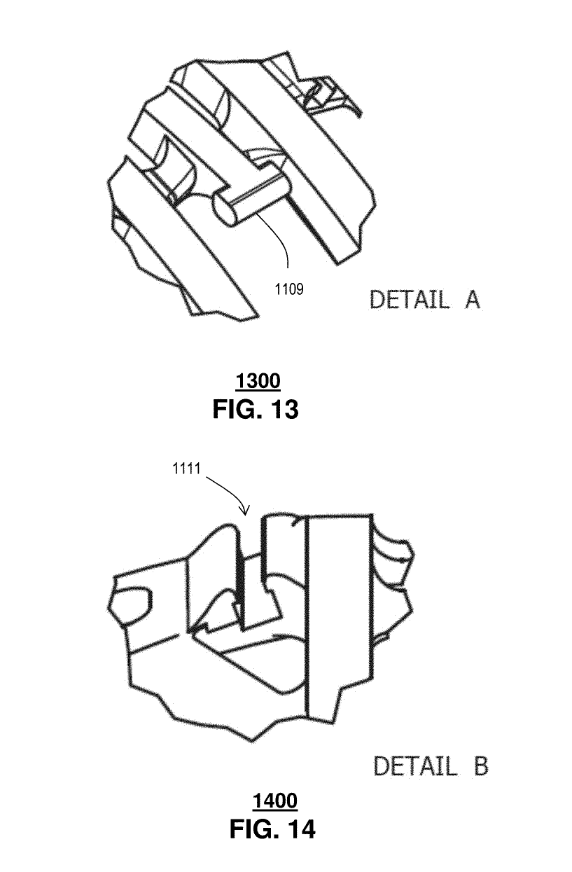

FIG. 13 depicts a schematic view of a first detailed portion of the example lever assembly 1200 depicted in FIGS. 12A-D, highlighting placement and shape of the example anchor 1109. Likewise, FIG. 14 depicts a schematic view of a second detailed portion of the example lever depicted in FIGS. 12A-D, highlighting placement and shape of the example mounting slot or channel 1111.

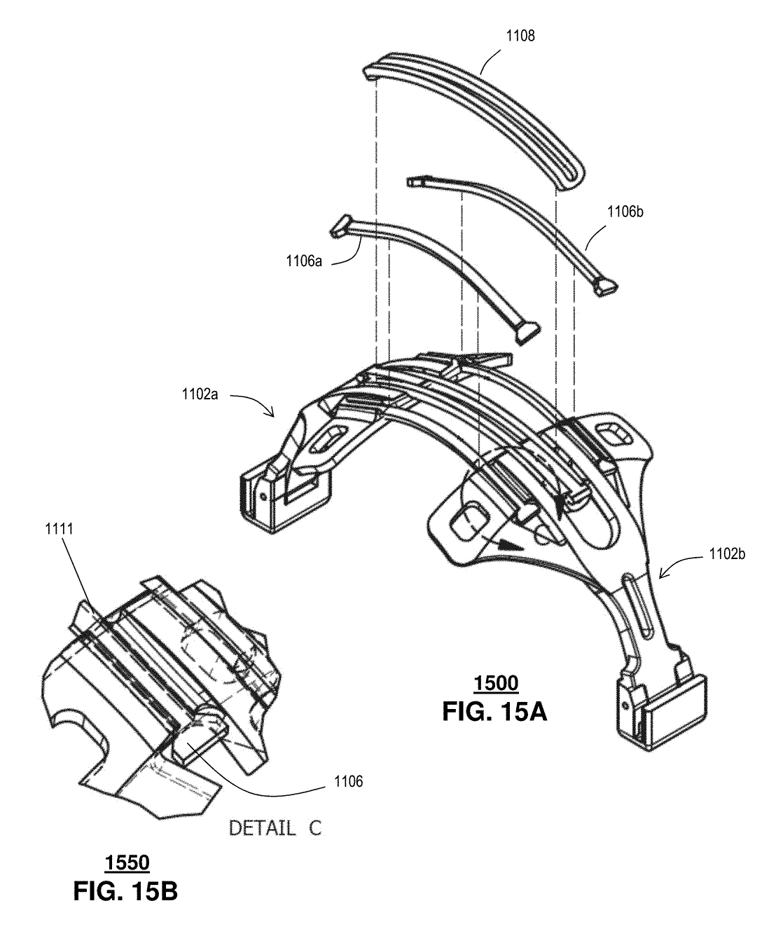

FIG. 15A depicts an exploded view 1500 of the example lever-actuated helmet shock abatement system 1100 depicted in FIGS. 11A-D. FIG. 15B depicts a schematic view of a detailed portion of the example lever 1102b depicted in FIG. 15A. In particular, the detail view portrays an end portion of the sacrificial member 1106 disposed within the mounting slot 1111, including the enlarged end providing an interference fit with the mounting slot 1111.

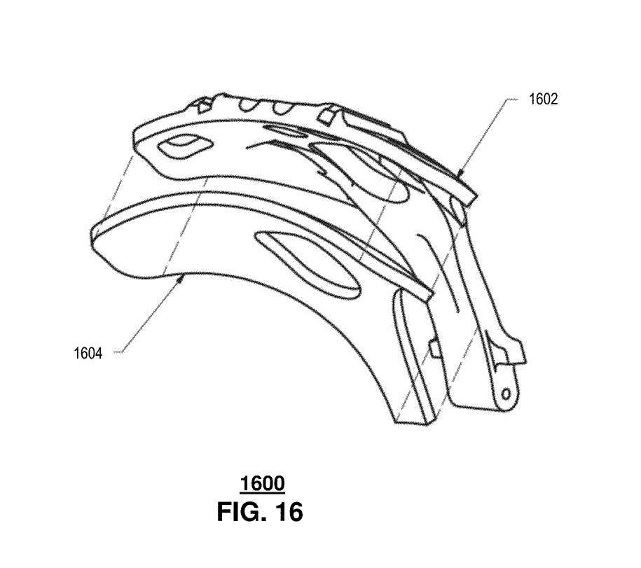

FIG. 16 depicts a schematic view of another example lever assembly 1600 of the example lever-actuated helmet shock abatement system depicted in FIGS. 11A-11D. The example lever assembly 1600 includes a lever 1602 and a deformable member 1604, such as a foam and/or a padding. A static use mode refers to a helmet worn upon a user's head, without being subject to any substantial external forces, such as impulsive forces as might be experienced when the helmet collides against another structure. The deformable member 1604, can include one or more pads or similar features to provide comfort to the user's head during use. It is understood that the pads 1604 can include compressible elements, compressible materials including resilient materials, such as foams, sponges, gels, elastomers, springs and the like to facilitate comfort during static use and/or shock abatement during periods of dynamic use, e.g., during a collision.

It is understood that one or more of the pads 1604 can be in contact with the user's 104 during such static use periods. In the illustrative example, substantially an entire bottom surface of the pad 1604 would be in contact with the user's head according to the contour of the lever 1602 and the conforming contour of the pad 1604.

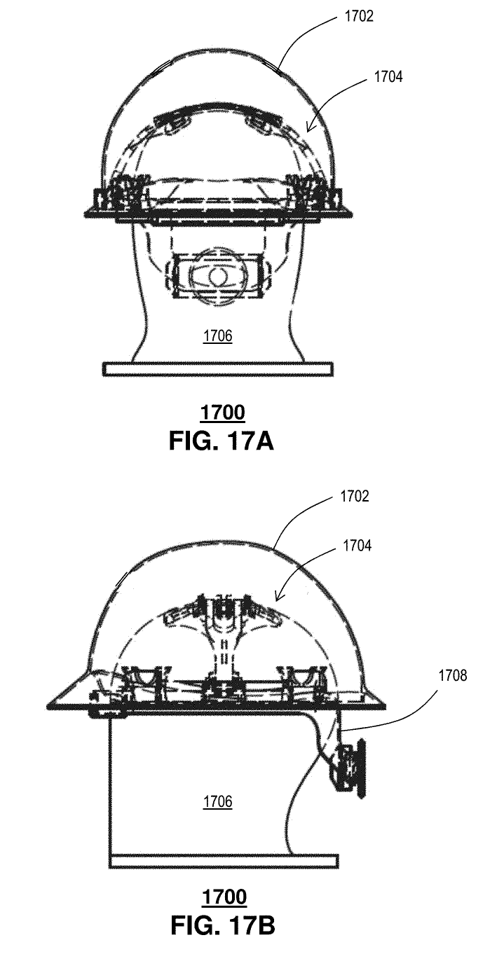

FIGS. 17A-17B depict front and side views of another example helmet-style shock abatement system 1700. The system 1700 includes a helmet shell 1702 and a helmet suspension assembly 1704. The helmet suspension assembly 1704 can include any of the various configurations disclose herein, such as the example mechanically fused lever assembly 1100 (FIGS. 11A-15B). In at least some embodiments, the system 1700 can include an adjustment band 1708 adapted to facilitate a secure and comfortable fit to a user's head and/or neck. When the adjustment band 1708 is tightened, it does not interfere with operation of the lever assembly 1704. Namely, the levers are able to rotate in response to an impact. In the illustrative embodiment, the adjustment band 1708 also has an occipital support with adjustment mechanism of the ratchet kind. However other embodiments can use any of the available adjustment mechanisms and/or occipital supports.

The adjustment band 1708 in this embodiment can be made of a flexible material with high tensile resistance like polymers, e.g., polypropylene. This material can be injected, casted, press-cut formed, or the like, using known manufacturing techniques to fully form all the details of the grooves needed for the adjustment mechanism. However, other embodiments that use other adjustment mechanisms can use different means of manufacturing, such as punching. Any flexible material with relatively high tensile strength can be used like other polymers, leather, metals, foils, etc.

In operation, a first portion of an impact force and/or kinetic energy of a collision between a lever-actuated helmet system and an external disturbance is redistributed based on the actuating of the levers of any of the various embodiments disclosed herein. Redistribution can include a change in direction. For example, a collision force received along a line of action can produce a change in motion of the collision receiving body, such as a movement of at least the outer portion of the helmet system. A resulting impact force, and/or a relative motion between the outer portion of the helmet system, e.g., resulting from a transfer of energy, can squeeze the machine 100 along a first direction, e.g., generally towards the protected object along the line of action, e.g., along the direction of a collision force F. Actuation of the machine 100, however, causes movement of one or more portions of the machine 100 that introduces forces upon one or more of the helmet shell and the user's head.

In at least some embodiments, resulting forces act on the user's head in directions that are orthogonal to the line of action and/or the impact force F acting upon the force processing mechanism. In at least some embodiments, the redistributions or redirection can introduce opposing forces acting upon the user's head. It is understood that the user's head can experience a resulting compression, e.g., without a corresponding translation and/or rotation. In at least some embodiments, the resulting forces act on the user's head in directions that are substantially opposite to the line of action and/or the impact force acting upon the force processing mechanism.

In at least some embodiments, a second portion of the impact force and/or kinetic energy of the collision that would otherwise be transferred toward the user's head is expended, absorbed, and/or otherwise reduced. This expenditure can include one or more of absorbing and/or dissipating energy associated with the collision. The absorbing and/or dissipating energy can occur, at least in part, along a direction other than the line of action. Alternatively or in addition, a reduction of at least a portion of the impact force can include an elastic and/or plastic behavior of materials to transform at least a portion of impact kinetic energy. Namely, impact energy can be absorbed by a break or fracture, a dent, a deformation and/or other temporary and/or permanent alteration of a protective system component. For example, some protection systems, such as motorcycle and/or bicycle helmets that are designed to break, fracture and/or otherwise deform in response to a collision. In at least some embodiments, energy absorption can be accomplished by distortion of a resilient and/or compliant member. Alternatively or in addition, the system can include a sacrificial member adapted to plastically deform up to a point of failure, at which time the sacrificial member breaks. Examples include, without limitation, storing kinetic energy of the collision in mechanical energy, e.g., potential energy of a distorted spring, a compressed resilient pad, and the like.

In a dynamic response mode or configuration. The helmet system worn upon the user's head is subjected to an external force, F, e.g., a vertically downward force. The external force F, e.g., resulting from a collision of the helmet shell with another object, is applied to an exterior surface of the helmet shell. The force F pushes the helmet shell downward with respect to the user's head. By way of example, and in reference to the helmet system 100 of FIG. 1, the fulcra 106 securely engage the helmet shell, e.g., by way of a friction fit between the pivot anchors 104 and an accessory slot of the helmet shell, and move downward in a corresponding manner with respect to the user's head. A relative movement of the helmet shell, the fulcra 106 and the user's head decreases the separation distance between the top of the user's head and the facing portion of an interior surface of the helmet shell to a distance h″, where h″<h′. The relative movement forces the top ends 105 of the levers 102 outward by a relative upward movement of the user's head within the helmet shell. The user's head provides a reaction force that results in a rotation of the levers 102 about the respective fulcra 106, as shown. To the extent the pivot is located between the ends, the resulting rotation would cause bottom portions 107 of the levers 102 to move inward towards the user's head.

Additionally, the rotation of the levers results in a separation of the top ends 105 of the levers 102, resulting in an increased separation distance L″, where L″>L′. The expansion in the separation distance applies a tension to the deformable member 108 causing a distortion of the deformable member 108, e.g., and elongation. The elongation of the deformable member 108 results in a conversion of at least a portion of kinetic energy resulting from the collision into potential energy in the form of the distorted spring.

Beneficially, rotation of the levers 102 provides several advantages that facilitate an abatement of the collision force acting upon the user's head and/or other parts of the body, such as the neck, spine and the like. For example, rotations of the levers 102 reconfigured at least a portion of the downward or vertical force F into a different direction, e.g., a horizontal direction, pushing inward on side portions of the user's head. Thus, at least a portion of the downward force F that would otherwise tend to compress a user's neck and/or spine is converted to opposing lateral forces that tend to compress the user's head, without necessarily moving and/or compressing the spine.

Moreover, that portion of the kinetic energy that is converted to potential energy in the deformable member 108 is absorbed or otherwise prevented from acting upon the user's head or body. In the illustrative example, removal of the force F, e.g., after a collision, can result in a subsequent transfer of at least some of the potential energy of the deformable member 108 into kinetic energy of the levers 102 to rotate the levers back towards their original static use positions. Such backward rotation can result in a relative movement of the helmet shell and the user's head, e.g., to increase the separation distance from h″ back to h′. It is anticipated that such releases of potential energy will not result in forces that would otherwise injure the user.

In some embodiments, one or more of the levers 1102 (FIGS. 11A-D) can be configured to twist. For example, the twisting can be in response to a force applied to one or more elongated extensions at either or both ends of a lever assembly 1100. In some embodiments, twisting is permitted by one or more of a mechanical configuration or a choice of material. Twisting of one or more of the levers 1102 can contribute to deformation of one or more deformable members 108, and/or springs, e.g., to convert a kinetic energy to a potential energy based at least in part on the twisting. In at least some embodiments, twisting includes a rotational displacement of one end 1105 of a lever 1102 with respect to an opposing end 1107 of the lever 1102.

In at least some embodiments, one or more of the elongated portion 1103 of the lever 1102 and the ends 1105, 1107 are substantially rigid and joined by way of a linkage (not shown) that facilitates a twisting. Alternatively or in addition, a twisting can be facilitated by a pivot about which the lever rotates. For example, the pivot can be flexibly mounted to one of a mounting frame and/or an interior surface of the protective shell or helmet. It is understood that one or more of the levers can include one or more joints, such as ball and socket joints.

In some embodiments, the lever assembly can be assembled as a self-contained, wearable unit. For example, a lever assembly can be assembled into a free-standing assembly that can be worn with or without a protective shell. It should be understood that the shock abatement systems disclosed herein can be assembled into free-standing assemblies and used without protective shells. Such free-standing assemblies can be pre-assembled and inserted into or otherwise combined with protective shells. Alternatively or in addition the shock abatement systems can be combined with one or more protective shells and/or assembled in combination with such shells. In some embodiments, one or more components, e.g., the fulcra, can be attached to and/or integrally formed with the protective shell. It is envisioned that in at least some embodiments, one or more cantilevered segments can be formed by removing material from a portion of a shell. At least one of the one or more cantilevered segments can be operatively coupled to one or more of the example levers and/or lever assemblies disclosed herein to redistribute a non-trivial portion of a collision energy that absorbs and/or dissipates energy in directions other than a line of impact of the collision.

In some embodiments, lever rotation can occur within a plane. Consider a hinge-type pivot in which rotation is substantially constrained to a plane substantially perpendicular to an axis of the pivot. Alternatively or in addition, rotation can occur more freely, e.g., within three dimensions. Consider a point fulcrum in which the lever 102 can rotate in three dimensions. By way of non-limiting arrangements, a pivot can include a ball-and-socket style joint or coupling. Such an engagement can include a partially spherical protrusion, e.g., a ball or a partially spherical cavity, e.g., a socket positioned at a pivot location along the lever 504 and a corresponding socket or ball positioned at an adjacent fulcrum. The ball-and-socket joint generally allows for multidirectional movement and rotation.

In some embodiments, the shock abatement system also includes a mounting structure, e.g., a mounting frame, bracket or ring (not shown) to which the levers of the lever array are pivotally attached. The mounting frame can include an enclosed ring, e.g., a circle or an oval, e.g., an ellipse or egg shape. The mounting frame can include a fulcrum for each of the levers.

One or more of the deformable members can include a spring, a, a resilient material, a compliant material, a conformable material, or any combination thereof. Deformable materials can include, without limitation, elastomers, foams, rubbers, polymers, gels, composites and the like. It is understood that one or more of the deformable members can be in contact with a portion of a body, such as a human head, face and/or neck. One or more of the deformable members can be configured to touch the body during normal wear, e.g., static use, during periods of reaction to external forces including impulsive or impact forces as might be experienced during a collision, and/or subsequent to any such collisions.

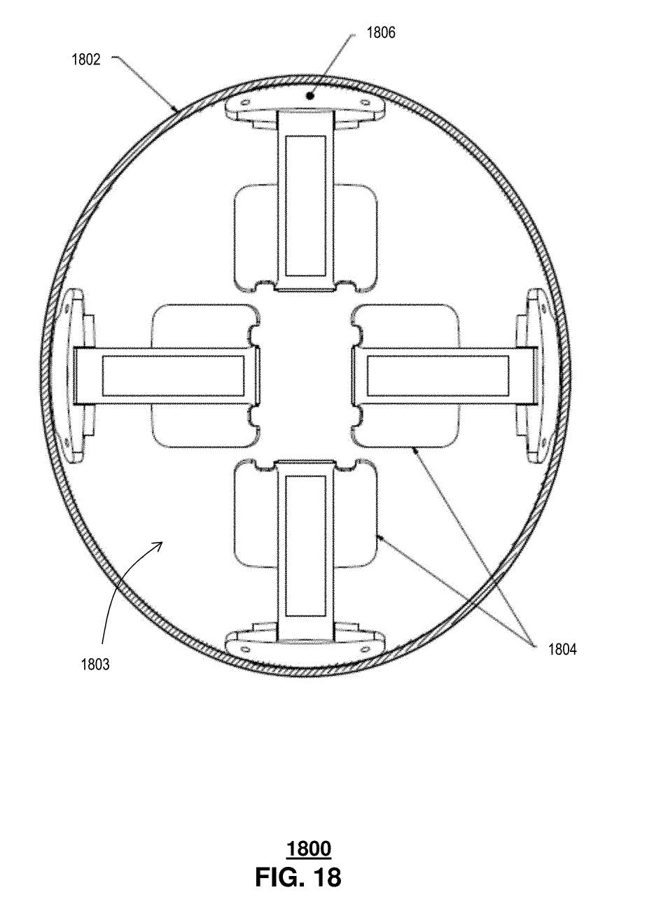

FIG. 18 depicts a top cross-sectional view of another example helmet-style shock abatement system 1800 including a helmet shell 1802 and a lever assembly 1803. The lever assembly 1803 includes two pairs of opposing levers 1804, each pair rotationally displaced from the other by about 90 degrees with respect to a central body axis. Each lever 1804 is pivotally joined to the helmet shell 1802, e.g., at a base portion of the lever, e.g., at a respective pivot anchor 1806. Consequently, each lever 1804 is adapted to pivot or rotate about its respective pivot anchor 1806.

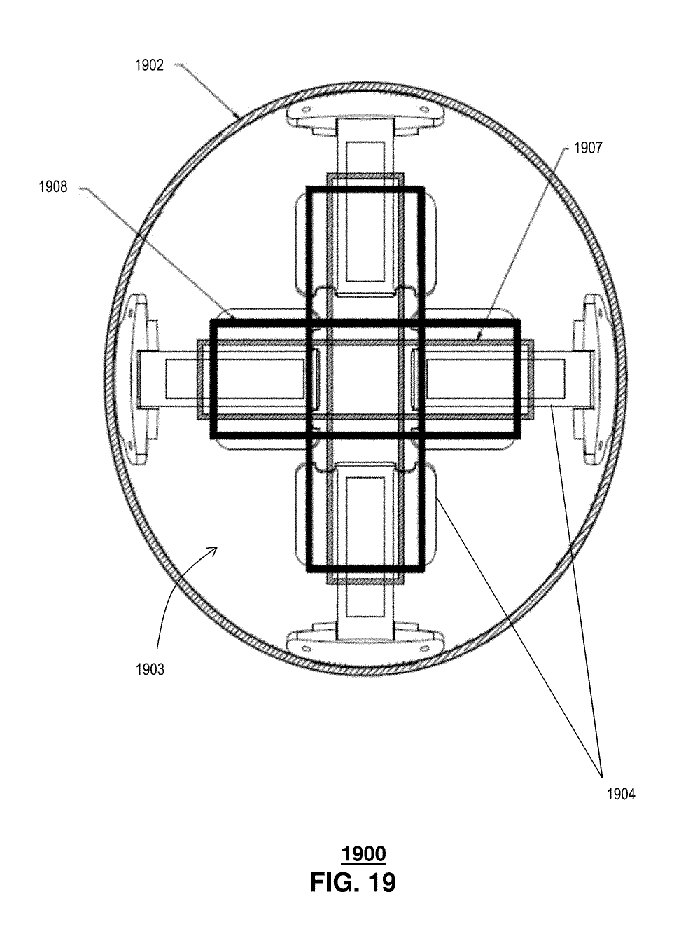

FIG. 19 depicts a top cross-sectional view of another example helmet-style shock abatement system 1900 including a helmet shell 1902 and a lever assembly 1903. The lever assembly 1903 includes two pairs of opposing levers 1904, each pair rotationally displaced from the other by about 90 degrees with respect to a central body axis. Each lever 1904 is pivotally joined to the helmet shell 1902, e.g., at a base portion of the lever, e.g., at a respective pivot anchor 1906. Consequently, each lever 1904 is adapted to pivot or rotate about its respective pivot anchor 1906.

The lever assembly 1903 further includes a pair of sacrificial members 1907. Each sacrificial member 1907 of the pair is in communication with top portions of an opposing lever pair 1904. The example configuration includes a loop configuration, e.g., circular and/or rectangular loop, in which ends of the loop are wrapped around top portions of the levers 1904, such that a separation of the top portions of the levers 1904, e.g., as induced by their pivoting about respective pivots 1906, causes a plastic deformation of the sacrificial member and/or fracture 1907. At a sufficiently large separation distance the sacrificial member 1907 can experience mechanical failure, e.g., breaking.

Alternatively or in addition, the lever assembly 1903 further includes a pair of elastomeric members 1908. Each elastomeric member 1908 of the pair is in communication with top portions of an opposing lever pair 1904. The example configuration includes a loop configuration, e.g., circular and/or rectangular loop, in which ends of the loop are wrapped around top portions of the levers 1904, such that a separation of the top portions of the levers 1904, e.g., as induced by their pivoting about respective pivots 1906, causes an elastic and/or plastic expansion of the elastomeric member 1908. In at least some embodiments, one or more of the elastomeric members 1908 remains engaged and in elastic expansion after failure of any and/or all of the sacrificial members 1907, when present.

Although single sacrificial member loops 1907 and elastomeric loops 1908 are shown between opposing pairs of levers, it is understood that other configurations are possible. For example, multiple sacrificial member loops 1907 and/or elastomeric loops 1908 can be used for a single pair of levers. Alternatively or in addition, one or more of the sacrificial member loops 1907 and/or elastomeric loops 1908 can engage any number of levers, including more than a single pair, and in some instances, up to all of the levers. Likewise, although four vertically aligned levers 1904 arranged in opposing pairs are shown, it us understood that a greater number and/or fewer number of levers 1904 can be used. The levers can include vertically aligned levers, horizontally aligned levers, and/or any other conceivable alignment and/or orientation, without restriction.

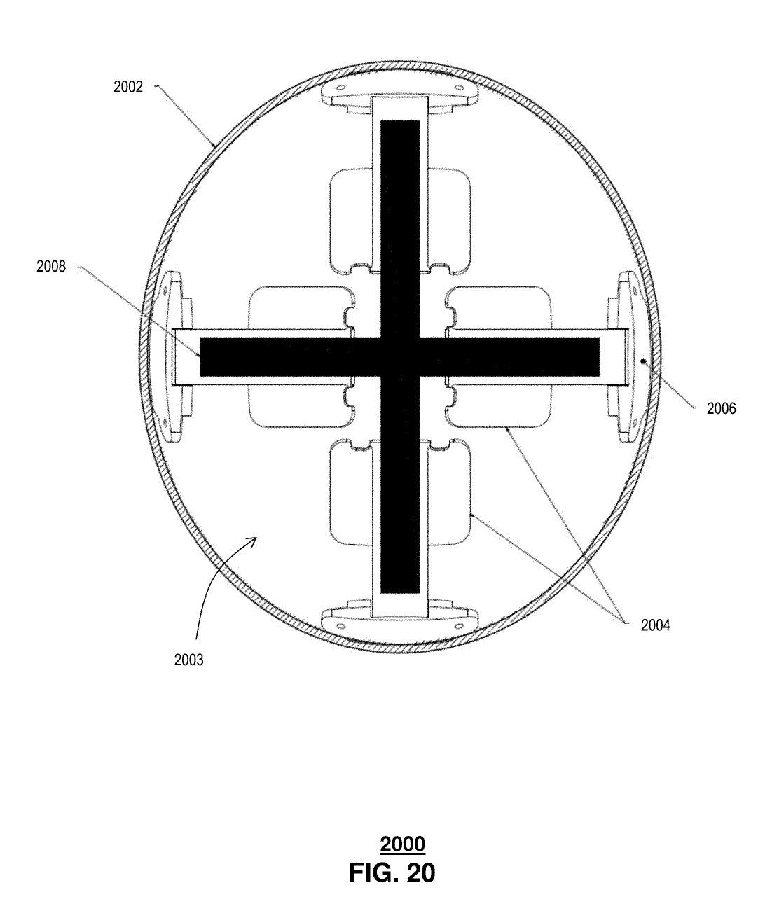

FIG. 20 depicts a top cross-sectional view of another example helmet-style shock abatement system 2000 including a helmet shell 2002 and a lever assembly 2003. The lever assembly 2003 includes two pairs of opposing levers 2004, each pair rotationally displaced from the other by about 90 degrees with respect to a central body axis. Each lever 2004 is pivotally joined to the helmet shell 2002, e.g., at a base portion of the lever, e.g., at a respective pivot anchor 2006. Consequently, each lever 2004 is adapted to pivot or rotate about its respective pivot anchor 2006.

The lever assembly 2003 further includes at least one elastomeric member 2008. The elastomeric member 2008 is in communication with top portions of multiple levers 1904, and in the illustrative example, in communication with top portions of all of the levers 1904. For example, the elastomeric member 2008 includes apertures adapted to engage protruding hooks or posts of the levers. The example configuration includes a “star” shaped elastomer 2008 including extensions or arms that engage respective levers 1904. Physical separation of top portions of the levers 2004, e.g., as induced by their pivoting about respective pivots 2006, causes an elastic expansion of the elastomeric member 2008.

In at least some embodiments, the lever assembly can include one or more sacrificial members 1907 (FIG. 19). The sacrificial member(s) 1907, when provided, can operate as defined herein. In at least some embodiments, the elastomeric member 2008 remains engaged and in elastic expansion after failure of any and/or all of the sacrificial members as may be present.

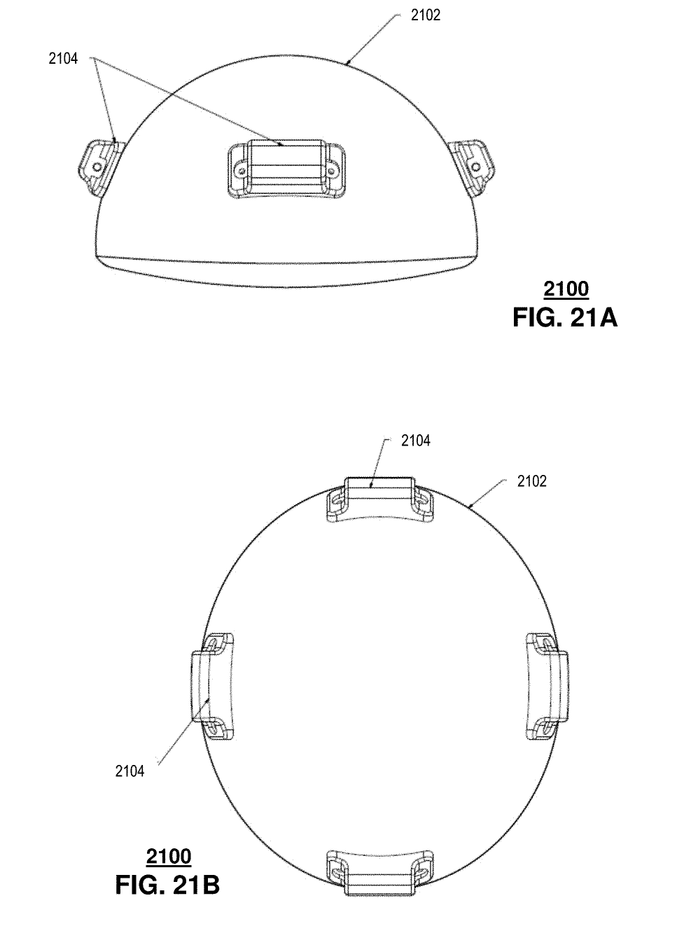

FIGS. 21A-21B depict front and top views of another embodiment of a helmet assembly 2100. The helmet assembly 2100 includes a shell 2102 and a number of pivot anchors. As placement of pivot anchors may require more space within the helmet than available, at least some of the pivot anchors can be positioned at least partially external to the shell 2102. In the illustrative example, the shell 2102 includes four apertures, each sized, shaped and positioned to accommodate a portion of a respective pivot anchor 2104. The pivot anchors 2104 can include an outer portion that resides external to the shell 2102 and an internal portion adapted to pivotally engage a respective lever. Such external placement of at least portions of the pivot anchors outside the helmet shell 2102 gains space to place a machine, e.g., levers, elastomers and/or sacrificial members, inside the helmet shell 2102. In small shells 2102 and with shock abatement systems that incorporate front and back levers, space can be gained by incorporating a housing that permits to locate the lever pivots outside the shell 2102.

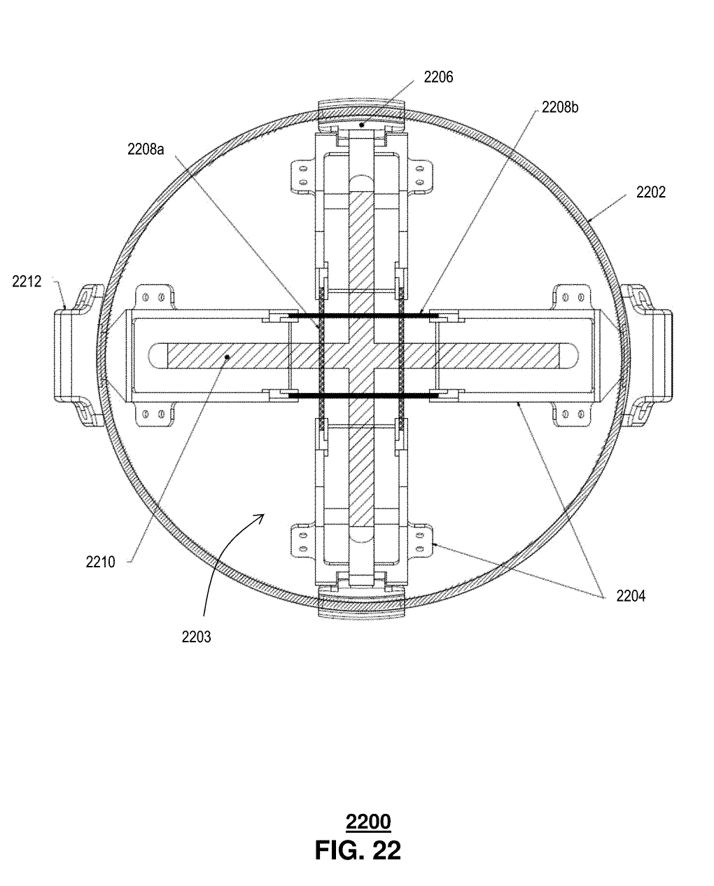

FIG. 22 depicts a top cross-sectional view of another example helmet-style shock abatement system 2200 including a helmet shell 2202 and a lever assembly 2203. The lever assembly 2203 includes two pairs of opposing levers 2204, each pair rotationally displaced from the other by about 90 degrees with respect to a central body axis. Each lever 2204 is pivotally joined to the helmet shell 2202, e.g., at a base portion of the lever, e.g., at a respective pivot anchor 2206. Consequently, each lever 2204 is adapted to pivot or rotate about its respective pivot anchor 2206.

The illustrative embodiment of the lever assembly 2203 includes a “star” shaped elastomeric member 2210, e.g., similar to the star shaped elastomeric member 2008 (FIG. 10). The star shaped elastomeric member 2210 engages some or all of the levers 2204, such that rotation of the levers induces an expansion of the elastomeric member 2210. Likewise, the illustrative embodiment of the lever assembly 2203 includes a pair of sacrificial members 2208a, 2208b, generally 2208. The example sacrificial members 2208 includes loop configurations, e.g., circular and/or rectangular loops. Each sacrificial member 2208 of the pair is in communication with top portions of an opposing lever pair 2204. Instead of being wrapped around the levers 2204, however, the loops of the sacrificial members 2208 engage hooks and/or latches provided at the ends of the levers 2204. Once again, separation of the top portions of the levers 2204, e.g., as induced by their pivoting about respective pivots 2206, causes a plastic deformation of the sacrificial member 2208. At a sufficiently large separation distance the sacrificial member 2208 can experience mechanical failure, e.g., breaking. In at least some embodiments, one or more of the elastomeric members 2210 remains engaged and in elastic expansion after failure of any and/or all of the sacrificial members 2208, when present.

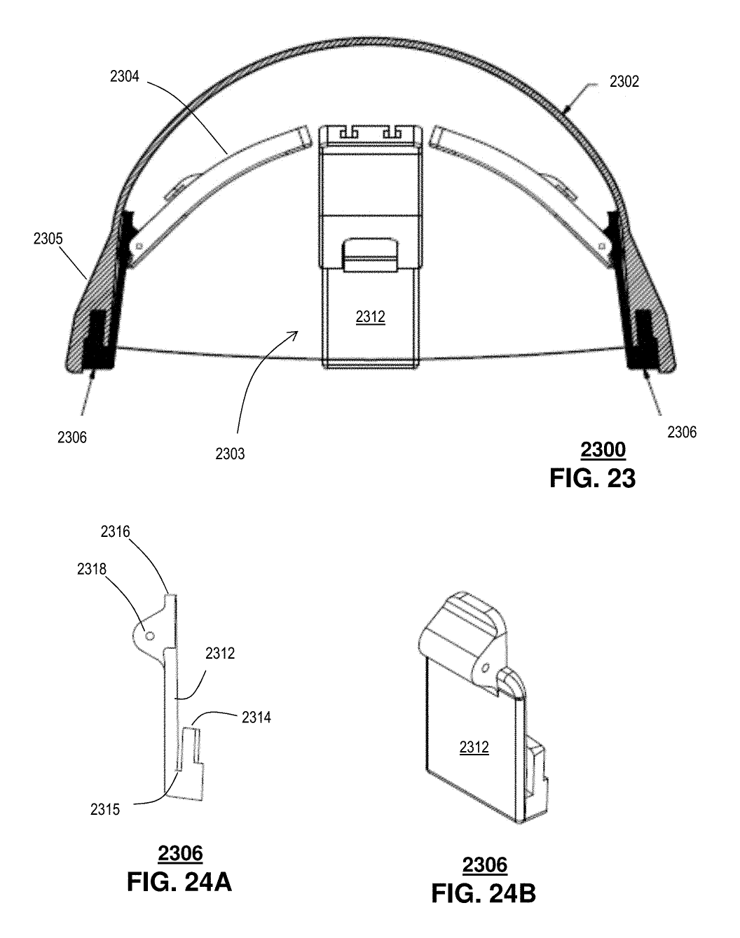

FIG. 23 depicts a front cross-sectional view of an alternative embodiment of a lever-actuated shock abatement helmet system 2300. The system 2300 includes a protective shell 2302 and a lever assembly 2303. The lever assembly 2303 includes one or more levers 2304 that are pivotally attached to respective pivot anchors 2306. The pivot anchors 2306 are adapted to frictionally engage a lower rim of the protective shell 2302, such that the pivot anchors are fixedly attached to the shell 2302 and substantially stationary during a collision event.

FIGS. 24A-B depict side and perspective views of the example pivot anchor 2306 depicted in FIG. 23. In particular, the pivot anchor 2306 includes a rigid segment 2312 extending between a lower end and an upper end. The lower end includes a slot 2315, e.g., defined between the lower end of the rigid segment 2312 and an opposing wall segment 2314. In some embodiments the opposing wall segment can include an extension, e.g., a blade, a plug, or the like, adapted to frictionally engage, e.g., plug into, an accessory attachment accommodation 2305. In at least some embodiments, e.g., those in which a helmet shell may not include an specific attachment accommodation, the slot 2315 provides interference fit between the pivot anchor 2306 and the helmet shell 2302, e.g., along a bottom rim of the helmet shell 2302. In the illustrative example the pivot anchor 2306 includes an upper extension that defines a pivot aperture 2318. The pivot aperture 2318 is adapted to engage a pin and/or axle to facilitate an axial rotation or pivoting of the lever 2304 about the pivot anchor 2306.

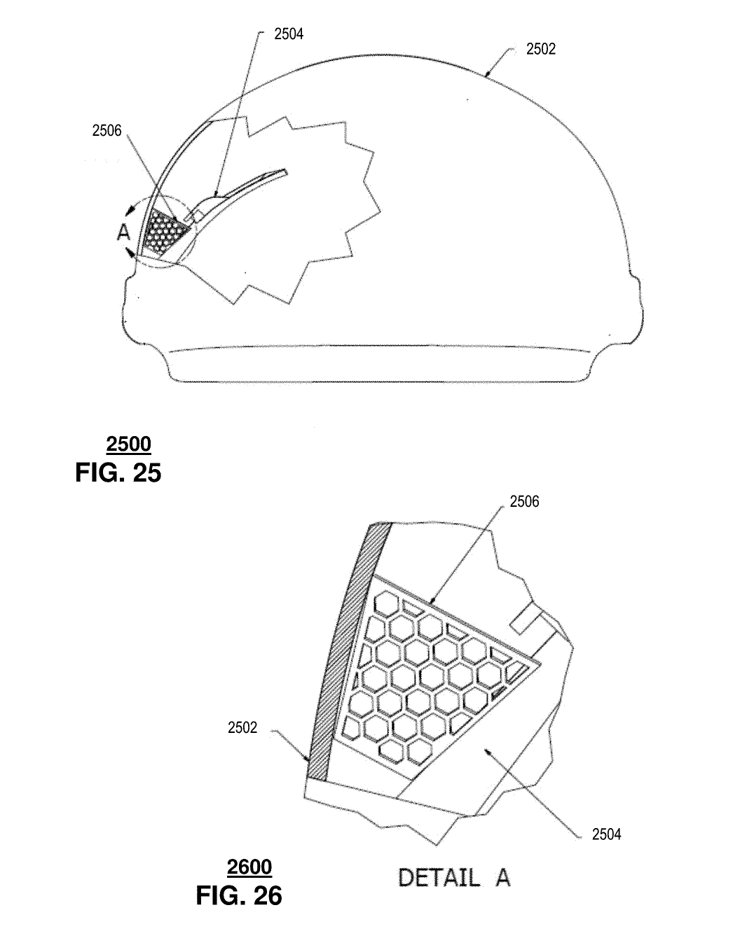

FIG. 25 depicts a side view of yet another example lever-actuated shock abatement helmet system 2500. The system 200 includes a protective shell 2502 including a lever assembly having at least one lever 2504. The at least one lever 2504 is in communication with a sacrificial member 2506. The sacrificial member 2506 is adapted to undergo a plastic deformation in response to rotation of the at least one lever 2504 to facilitate a transformation of at least a portion of kinetic energy of a collision strain energy, in the plastic region of the material. Beneficially, the energy expended in any of the plastic deformations disclosed herein is not transferred back to the system 2500 and/or user of the system 2500.

FIG. 26 depicts a schematic view of a detailed portion 2600 of the example lever-actuated shock abatement helmet system 2500 depicted in FIG. 25, highlighting details of the sacrificial member 2506. The sacrificial member 2506 includes a solid structure that includes one or more foldable and/or collapsible portions. When subjected to a force of a collision, a rotation of the lever folds and/or collapses the foldable and/or collapsible portions of the sacrificial member 2506. In at least some embodiments, the folding and/or collapsing includes plastic deformation of the solid material. By way of illustration, the solid material includes apertures, e.g., in the form of a honeycomb. An outward rotation of the lever 2504 towards the shell 2505 entraps the sacrificial member 2506, exerting a compressive force. The compressive force induces a folding and/or collapse of one or more of the apertures, according to a plastic deformation.

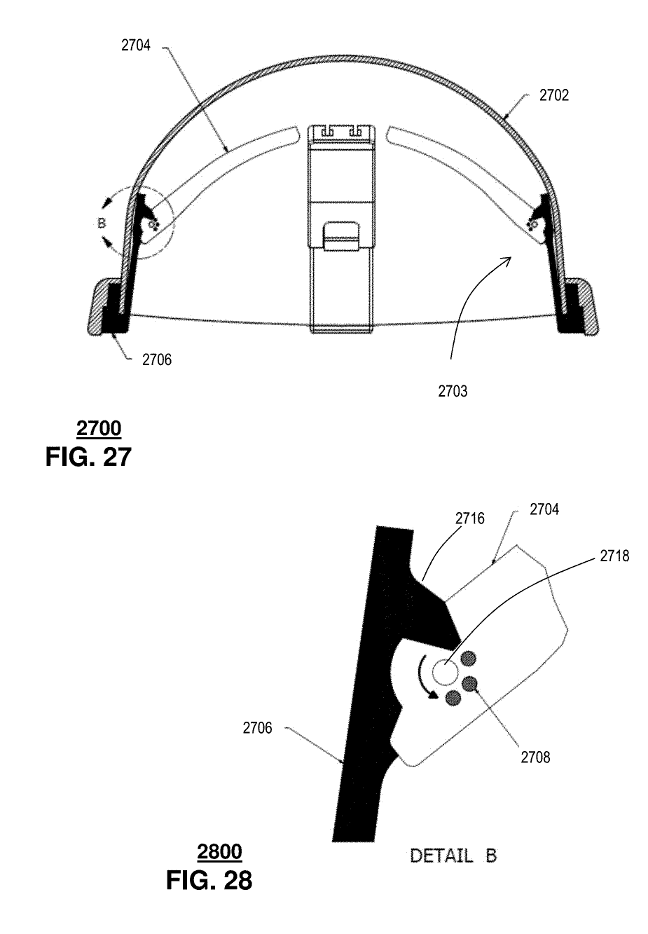

FIG. 27 depicts a front cross-sectional view of an alternative embodiment of a lever-actuated shock abatement helmet system 2700. The system 2700 includes a protective shell 2702 and a lever assembly 2703. The lever assembly 2703 includes one or more levers 2704 that are pivotally attached to respective pivot anchors 2706. The pivot anchors 2706 are adapted to frictionally engage a lower rim of the protective shell 2702, such that the pivot anchors are fixedly attached to the shell 2302 and substantially stationary during a collision event.

FIG. 28 depicts a side view of the example pivot anchor 2706 depicted in FIG. 27. In particular, an upper portion of the pivot anchor 2706 includes an upper extension including a cantilevered segment 2716 and defining a pivot location 2718. The pivot location 2718 is adapted to engage a pin and/or axle to facilitate an axial rotation or pivoting of the lever 2704 about the pivot anchor 2706. The illustrative embodiment includes one or more sacrificial elements 2708 positioned in proximity to the pivot location 2318. The sacrificial elements 2708 are adapted to transform kinetic energy of a collision to strain energy, in the plastic region of the material, by shearing forces. For example, the sacrificial elements 2708 can include an array of cylindrical stubs 2708 that extend outward away from the lever. For example, the cylindrical stubs 2708 can be aligned with a pivot axis. The cylindrical stubs 2708 are rotated into the cantilevered segment 2716 of the pivot anchor 2706. In response to encountering the cantilevered segment 2716, each of the sacrificial elements 2708, in turn, are deformed plastically by shearing forces provided by contact with the cantilevered segment 2716.

In some embodiments, one or more of the pivot anchor 2706, the lever 2704 and/or the sacrificial element 2708 can include a ratchet mechanism. The ratchet mechanism can include a resilient member, such as a spring, that stores energy during rotation of the lever 2704. The ratchet mechanism selectively engages during rotation in a first direction, e.g., counter clockwise, and is prevented from releasing stored energy by its preventing rotation in a second direction, e.g., clockwise.

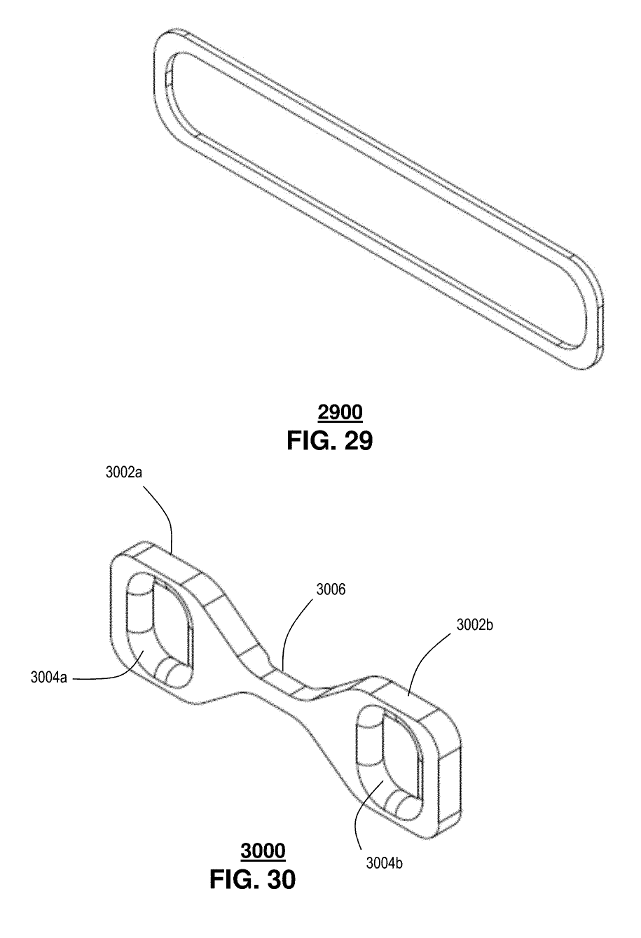

FIG. 29 depicts a perspective view of a sacrificial member 2900. The sacrificial member includes a rectangular loop formed in a planar fashion, e.g., cross section of the loop reveals rectangular cross sections of the loop segments. It is understood that other configurations are possible, such as linear members, and/or enclosed loop members including any shape, such as circular, elliptical, rectangular, triangular, polygonal, etc. Although the loop is substantially planar, it is understood that other non-planar configurations are possible, including three dimensional shapes. The sacrificial member material and/or methods of fabricating the same can include, without limitation, any of the various materials and techniques disclosed herein. Material combinations and sacrificial member or fuse design permit to have spring arrangements in parallel and/or series. In FIG. 2900, the rectangular design of the sacrificial member is intended to work as two springs in parallel. Sacrificial member materials can be thermoplastics, thermosets, elastomers, metals or any combination thereof (for example, tires combine different elastomers with an array of metal wires).

FIG. 30 depicts a perspective view of another embodiment of a sacrificial member 3000. The sacrificial member 3000 includes a pair of loops 3004a, 3004b, generally 3004, formed at respective end portions 3002a, 3002b. The loops 3004 are joined together by a mid-section 3006. It is understood that the entire sacrificial member can be formed form the same material or combination of materials. Alternatively, the sacrificial member 3000 can be formed from different materials, e.g., different materials for the loop ends 3002 and the mid-section 3006. Selection of materials and/or material configurations, e.g., size, width, depth, cross section, and the like, can be adapted to facilitate a controlled sacrificial member, e.g., fuse, performance. Once again, a cross section of the sacrificial member 3000 reveals rectangular cross sections of the loop end segments 3002 and/or mid-section 3006. It is understood that other configurations are possible, such as linear members, and/or enclosed loop members including any shape, such as circular, elliptical, rectangular, triangular, polygonal, etc. Although the loop is substantially planar, it is understood that other non-planar configurations are possible, including three dimensional shapes. The sacrificial member material and/or methods of fabricating the same can include, without limitation, any of the various materials and techniques disclosed herein.

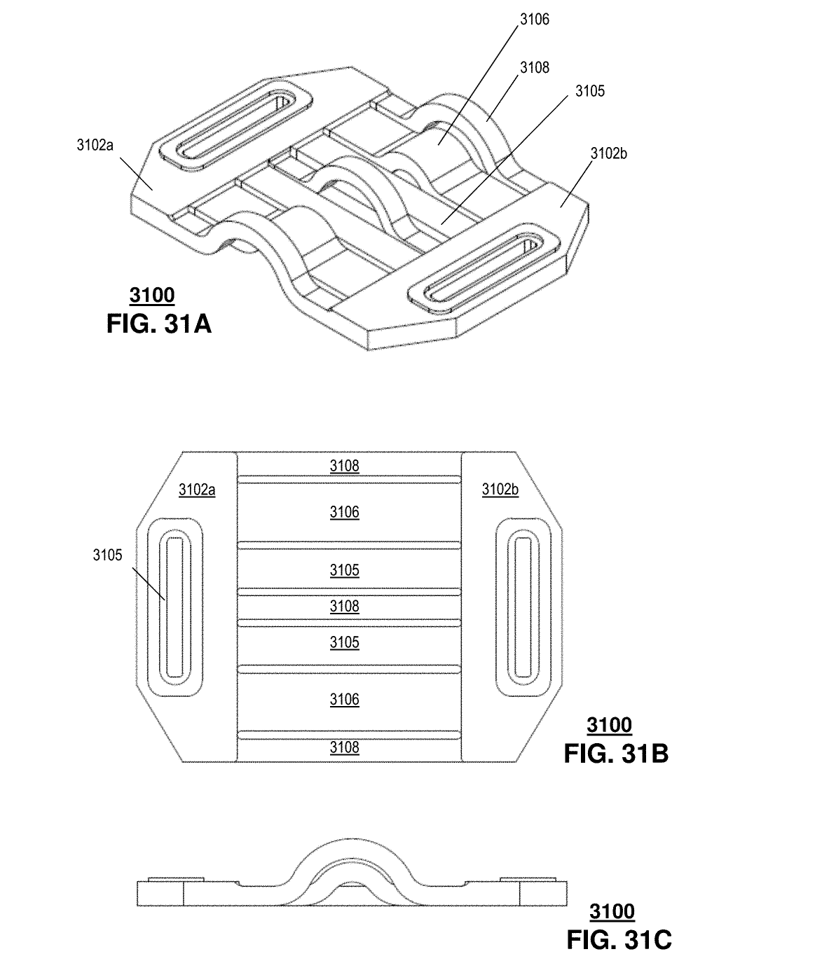

FIGS. 31A-31C depict perspective, top and side views, respectively, of another embodiment of a deformable member 3100. The deformable member 3100 can include one or more sacrificial member segments 3105, 3106, 3108, e.g., extending between opposing ends 3102a, 3102b, generally 3102. The sacrificial member segments 3105, 3106, 3108 can be adapted to plastically deform and/or fail according to different tensions. For example, a first sacrificial member segment 3105 can be designed to plastically deform and/or fail before any of the other sacrificial member segments 3106, 3108 fail. Likewise, a second sacrificial member segment 3106 can be designed to plastically deform and fail after the first sacrificial member segment 3105 has failed, but before a third sacrificial member segment 3108 fails. Similarly, the third sacrificial member segment 3108 can be designed to plastically deform and fail only after both the first and second sacrificial member segments 3105, 3106 have failed. In this manner, the sacrificial member segments operate according to respective thresholds. Control of plastic deformation and/or failure performance can be accomplished according to any of the techniques disclosed herein or otherwise generally known to those skilled in the art. In the illustrative example, the sacrificial member segments 3105, 3106, 3108 can be fabricated having different thicknesses and/or widths. Alternatively or in addition, the sacrificial member segments 3105, 3106, 3108 can be fabricated having different degrees of bend, warp or wave. For example, the greater the extent of the wave portions, the higher the threshold of plastic deformation and/or failure. One or more of the end portions 3102 can include an aperture 3105, adapted to engage an anchor on one or more of a lever, a pivotal anchor, and/or a helmet shell.

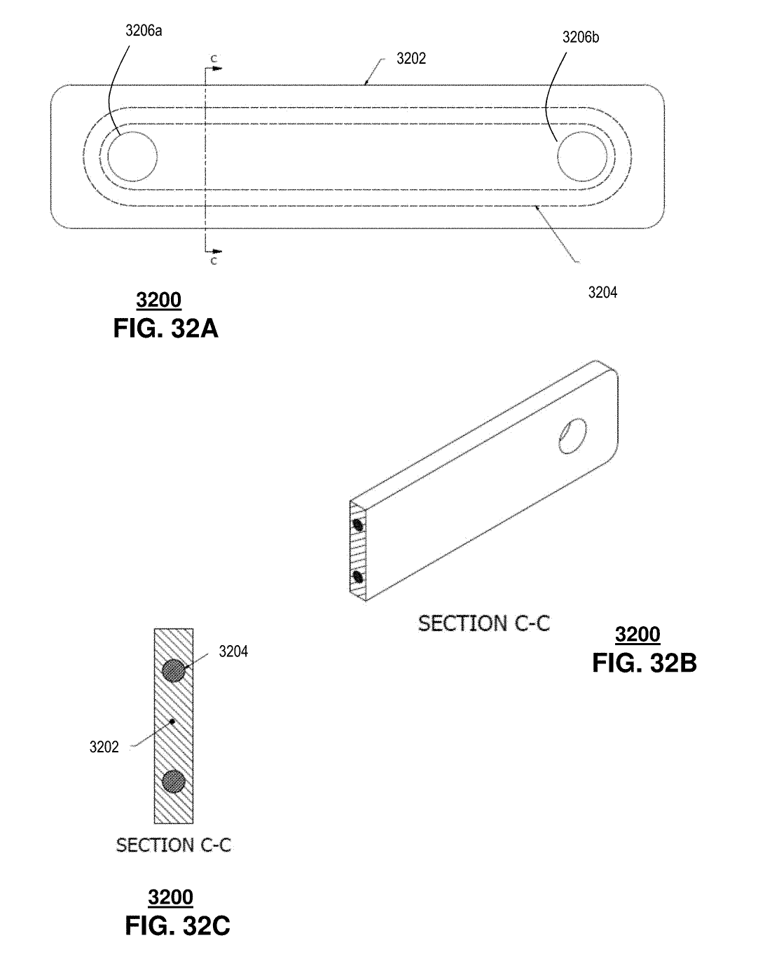

FIGS. 32A-32C depict top, sectional-isometric, and sectional views, respectively, of an embodiment of a compound deformable member 3200. The compound deformable member 3200 includes a first material 3202 forming a matrix that retains a second material 3204. In the illustrative example, the first material includes an elastomer 3202, whereas the second material includes a sacrificial member 3204. The elastomer 3202 can be formed as an elongated rectangle, including at least two apertures 3206a, 3206b, generally 3206, adapted to anchor the compound deformable member 3200 within a lever-actuated shock abatement system. Without limitation, the apertures 3206 can anchor the compound deformable member 3200 between levers, e.g., between opposing levers, and/or between levers and one or more of anchor pivots or protective shells.

In more detail, the sacrificial member 3204 is formed as an internal loop suspended within the elastomer 3202. In at least some embodiments, the loop is sized, shaped and/or positioned to include the at least two apertures, such that expansion of deformable member 3200 by way of the apertures 3206 provides a plastic deformation of the sacrificial member up to and including failure. After such plastic deformation and/or failure, the elastomer 3202 remains operable to store energy in response to further expansion/deformation. It is understood that in at least some embodiments, the roles and/or configuration of the sacrificial member and elastomer can be switched, such that the elastomer is embedded within a sacrificial member.

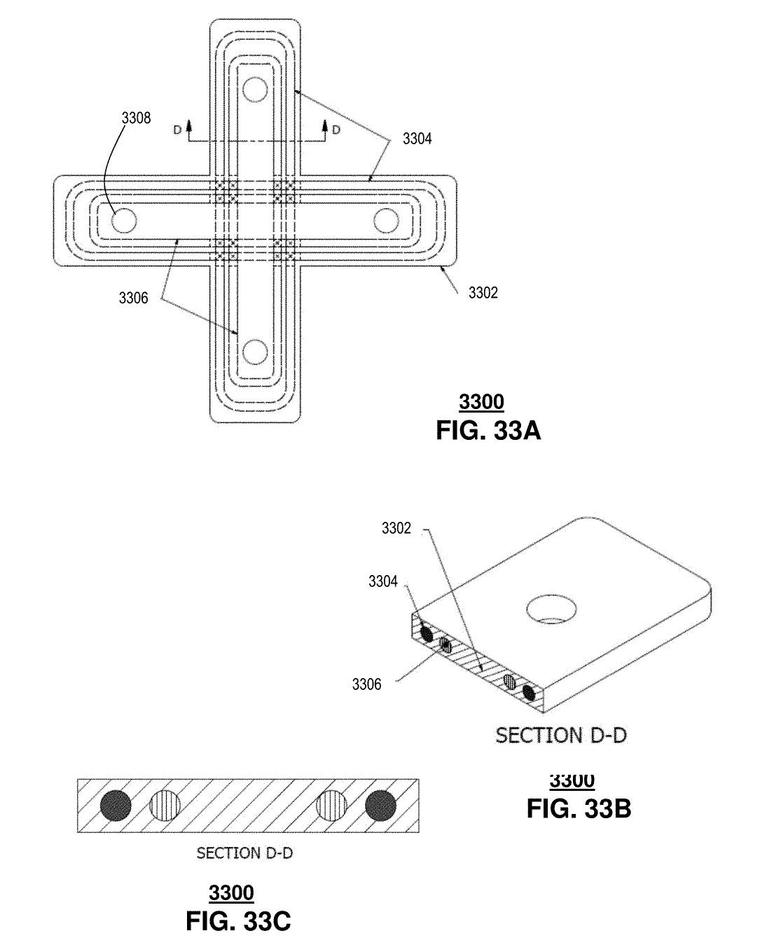

FIGS. 33A-33C depict top, sectional-isometric, and sectional views, respectively, of another embodiment of a compound deformable member 3300. The deformable member 3300 includes a first material, e.g., an elastomer 3302, formed in a cross, or star shape, e.g., to accommodate attachment to two opposing pairs of levers. Once again, the elastomer 3302 includes apertures 3308 to engage anchors on the levers. Likewise, the elastomer 3302 includes one or more pairs of sacrificial members 3304, 3306 suspended therewithin. The sacrificial members 3304, 3306 can include loop configurations that extend between opposing apertures and operate as described hereinabove. It is understood that multiple sacrificial members can be applied between the same opposing pair of levers, e.g., operating in a parallel fashion. In such configurations, it is understood that mechanical properties of the parallel sacrificial members 3304, 3306 can be the same or different. Consider at least one example, in which a first sacrificial member 3304 is adapted to operate at a lower threshold of lever separation; whereas, a second sacrificial member 3306 is adapted to operate at a higher threshold of lever separation. With such configurations, it is possible to tailor a performance, e.g., an energy absorption, dissipation and/or redirection according to properties of the parallel sacrificial members 3304, 3306.

Once again, it is understood that in at least some embodiments, the roles and/or configuration of the sacrificial members and elastomer can be switched, such that the elastomer is embedded within a sacrificial member.

In some embodiments, the various shock abatement systems disclosed herein can include one or more springs that absorb and/or store energy in response to movement of the levers. The spring members can include a spring and/or an elastomeric material, such as an elastic band, a rubber band, or a resilient O-ring. Although the illustrative examples portray an enclosed elastomeric loop, it is understood that any deformable material and/or configuration can be used. For example, a top portion of one of the levers can be attached to a top portion of one or more of the other levers by one or more springs. For example, springs can be used between adjacent levers, and/or between non-adjacent levers, e.g., between opposing levers. According to any of the example configurations, an impact or collision force induces a rotation of one or more of the levers, which results in a deformation of the one or more spring members and/or operation of the sacrificial members to absorb, and/or store, and/or dissipate kinetic energy of the impact/collision. It is understood that deformations of any of the various devices and/or materials disclosed herein can include one of plastic deformations, elastic deformations, or any combination thereof.

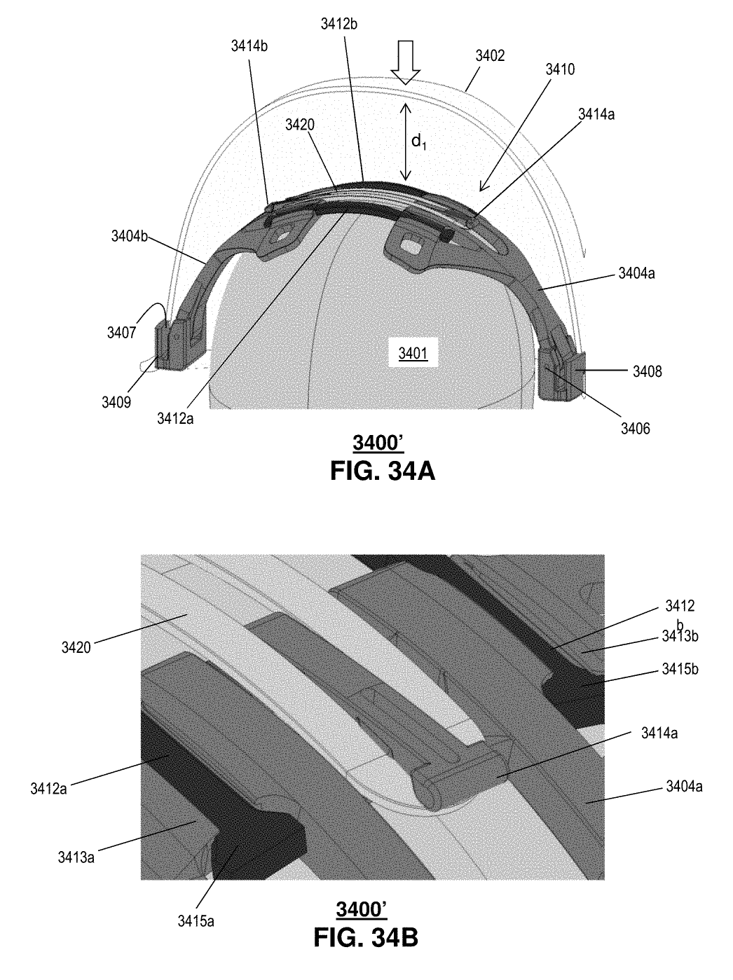

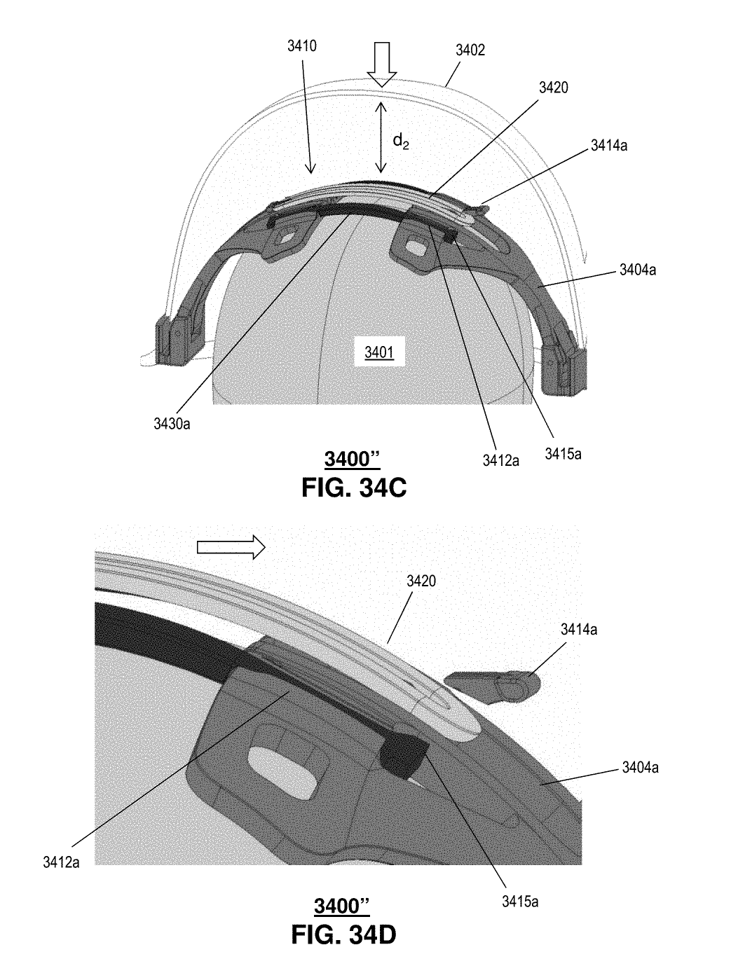

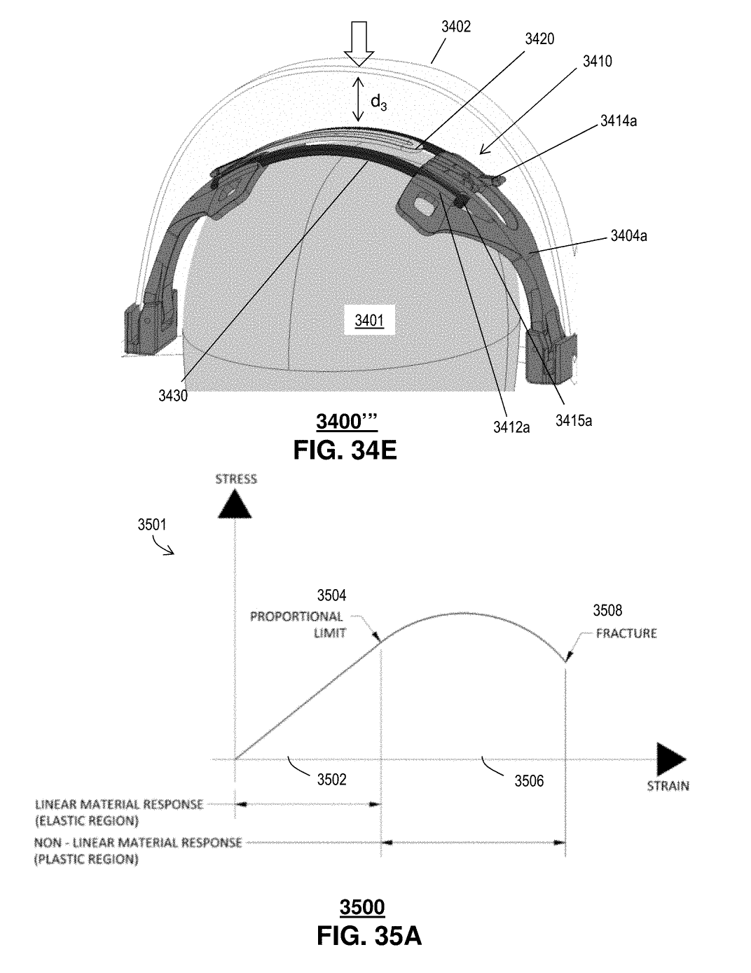

FIG. 34A depicts a top perspective view of another embodiment of a lever-actuated helmet shock abatement system 3400′. In particular, the system 3400′ is depicted in a first phase of operation referred to as pre-impact. The system 3400′ includes a lever assembly 3410 and a helmet shell 3402, adapted to be worn upon a head 3401 of a user. In the illustrative example, the lever assembly 3410 is adapted to abut at least a top portion of the user's head 3401 by resting upon the user's head 3401 providing a suspension for the helmet shell 3402. In a suspension role, the lever assembly 3410 preserves a separation distance d₁ between a top of the user's head 3401 and/or the top of the lever assembly 3410 and an inner surface of the helmet shell 3402. The separation distance d₁ offers advantages that include, without limitation, comfort, ventilation, and/or void to allow room for a translation of the helmet shell 3402 and/or a deformation of the helmet shell 3402. In at least some embodiments, the separation distance d₁ allows for a deformation and/or actuation of the suspension system. Distance d₁ can be referred to as impact stopping distance as it establish a limit for a minimum force required to stop the impact mass (e.g., according to an ideal spring behavior). For example, an impact on an external surface of the helmet shell 3402 may result in an inward deflection, bend and/or buckle. It is understood that such deformation of the helmet shell 3402 can absorb and/or deflect at least a portion of an impact force, while the preserved open space ensures that any such deformation occurs without touching the user's head 3401 and/or a top portion of the lever assembly 3410.

In more detail, the example lever assembly 3410 includes a pair of opposing levers 3404a, 3404b, generally 3404. It is understood that some embodiments can include more than two levers. Each lever 3404 also includes a helmet attachment portion, e.g., a pivot insert 3408, adapted to secure the lever assembly 3410 with respect to the helmet shell 3402. For example, the pivot insert 3408 includes a pivot portion that attaches to the lever 3404. The pivot portion can include a pivot joint 3406, such as an axle, one or more axle extensions, one or more axle accepting apertures, and the like. In at least some embodiments, the pivot insert 3408 includes a lever mounting portion. According to the illustrative embodiment, the lever mounting portion defines an open channel or slot 3407 sized and shaped to accept a lever-assembly mounting portion of the helmet shell 3402. The lever-assembly mounting portion can include, without limitation, a lower rim of the helmet shell 3402, an accessory mounting portion, a lever mounting portion and the like. According to the illustrative embodiment, the slot 3407 includes a lower wall portion 3409. The example lever-assembly mounting portion can be mounted to the helmet shell 3402 according to a frictional fit, a snap fit, an adhesive, a weld, a mechanical fastener, such as a snap, a screw, a staple, a rivet, hook-and-loop fasteners, and any combination thereof.

In the illustrative example, the pivot insert is provided at a lower end of each lever 3404. Each lever 3404 engages its respective pivot insert 3408 using a movable joint, such as a pivot joint 3406. The pivot joint 3406 allows for a pivoting motion of the lever 3404 about the pivot joint 3406. The pivot insert 3408 is adapted for secure attachment to a frame assembly and/or directly to the helmet shell 3402. As in preceding examples, the levers 3404 are shaped, e.g., having a curve, and in some instances a compound curve, to conform to an adjacent portion of a user's head and/or neck, when worn. Such contours offer comfort when worn and protection during an impact by providing a relative large contact area with the user's head 3401.

The example lever assembly 3410 includes at least a first member 3412 and a second member 3420 extending between the opposing levers 3404, and adapted to deform in response to forces exerted upon the deformable member(s) in response to the pivoting action of the levers 3404. It is understood that other configurations with a single member, either the first member 3412, the second member 3420, or other combinations of greater or fewer numbers of the two members 3412, 3420 are possible. According to the illustrative example, an outward rotation of the top ends of the opposing levers 3404 results in an increased separation between the top ends. The increasing separation can induce a force upon the deformable member(s), such as tension. Other forces can be induced, such as a compression, a bending and/or twisting.

It is further understood that the first and second members 3412, 3420 can have similar and/or identical shapes, e.g., both are loops, or both are strips. Alternative or in addition, the first and second members 3412, 3420 can have different shapes. Whether the shapes are the same, similar or different, the sizes of the first and second members 3412, 3420 can be similar, identical and/or different, e.g., some being relatively short in comparison to others. Shapes can differ in profile and/or cross section. For example, some of the first and second members 3412, 3420 can have a round or elliptical cross sectional profile, while others can have a triangular, rectangular, or more generally a polygonal profile.

In some embodiments, the second deformable member 3420 includes an elastic material, e.g., an elastomeric member 3420. As discussed further, hereinbelow, it is understood that the material properties of any of the first and second members 3412, 3420, and for that matter, any of the materials disclosed herein, may vary according to temperature. According to the illustrative embodiment, the first members 3412 are safety strips 3412 and the second member 3420 is an elastomeric loop 3420. Namely, a material described as an elastomer at one temperature range, may be characterized as having plastic, rigid and/or glassy properties at other temperature ranges. As anticipated operating temperature ranges of any of the disclosed embodiments can extend over a wide range, e.g., according to ANSI/ISEA Z89.1-2014: American National Standard for Industrial Head Protection: room temperature at 23° C.±3° C. (73.4° F.±5.4° F.); hot temperature at 49° C.±2° C. (120° F.±3.6° F.); higher temperature (Optional) at 60° C.±2° C. (140° F.±3.6° F.); cold temperature at −18° C.±2° C. (0° F.±3.6° F.); and lower temperature (Optional) at −30° C.±2° C. (−22° F.±3.6° F.). Other operating temperature ranges can include, without limitation, according to NOCSAE (National Operating Committee on Standards for Athletic Equipment): Standard Performance Specification for Newly Manufactured Football Helmets: hot temperature at 46° C.±3° C. (115° F.±5° F.). Although some example temperature ranges are provided, it is understood that the techniques disclosed herein can be applied to any temperature range.

The example elastomeric member 3420 is formed according to an enclosed structure, such as a loop, a flattened loop, an O-ring, and/or an elastic or rubber band, or more generally, any contoured shape and/or perimeter. Although enclosed loops are disclosed, other shapes are possible, e.g., lines, X's, stars, solids, strips and the like, The elastomeric loop 3420 is held in place between the levers 3404 by a pair of anchors, in this example, hooks 3414a, 3414b generally 3414. The loop 3420 is engaged at a beginning of a collision event by the hooks 3414 of the lever 3404. The example hooks 3414 include an elongated member attached at one end to the lever 3404 and extending away from the point of attachment. The example hooks 3414 further include an enlarged free end, e.g., having lateral protrusions adapted to facilitate retaining the elastomeric loop 3420 when positioned between the hooks 3414. Separation of the levers 3404 results in separation of the pair of hooks 3414, which, in turn, can stretch the elastomeric loop 3420. Stiffness profiles of the lever-actuated helmet shock abatement system 3400 can vary according to material properties, shapes, e.g., profiles, thicknesses, cross-sectional profiles, configurations, and so on. It understood that in at least some embodiments, one or more of the elastomeric loop 3420 and/or the hooks 3414 are adapted to fail or otherwise fracture or break under a predetermined stress. It is further understood that the range and/or point of failure can vary depending upon temperature conditions. In a stress range, the elastomeric loop 3420 may stretch to a point of failure, e.g., fracture or breakage. It is understood that failure and/or fracture at stresses beyond a threshold stress can be controlled by one or more of material selection, cross sectional shape, dimensions, e.g., thickness, stress concentration, and the like. In another configuration, the elastomeric loop 3420 may remain relatively rigid at cold temperatures, thereby deforming the hook, e.g., plastically, to a point of failure, e.g., fracture or breakage.

According to the illustrative embodiment of the lever-actuated helmet shock abatement system 3400′ the first pair of members 3412 are deformable sacrificial members. The safety strips 3412 are formed as elongated straight segments including enlarged end portions 3415a, 3415b, generally 3415. The safety strips 3412 are held in place between the levers 3404 by pairs of mounting slots 3413a, 3413b, generally 3413. Separation of the levers 3404 results in separation of opposing mounting slots 3413, which, in turn, stretches the safety strips 3412. The enlarged end portions 3415 generally prevent ends of the safety strips 3412 from sliding completely through their respective mounting slots 3413.

In at least some embodiments, the safety strips 3412 are sacrificial members 3412 that are adapted to plastically deform in response to separation of the levers 3404, up to and including a point of failure. Failure can include a fracturing and/or severing of the sacrificial member 3412. In at least some embodiments, the plastic deformation and/or mechanical failure can occur at any point along the sacrificial member. By way of example, a location of a point of plastic deformation and/or failure along a sacrificial member 3412 can be controlled by physical properties of the sacrificial member. Such physical properties can include, without limitation, cross section shapes, cross sectional dimensions, material choice, material density, a presence of apertures or holes, e.g., to concentrate stresses, and the like. In at least some embodiments, the mechanical failure can include failure of the enlarged ends portions and/or failure of the mounting slots 3413.

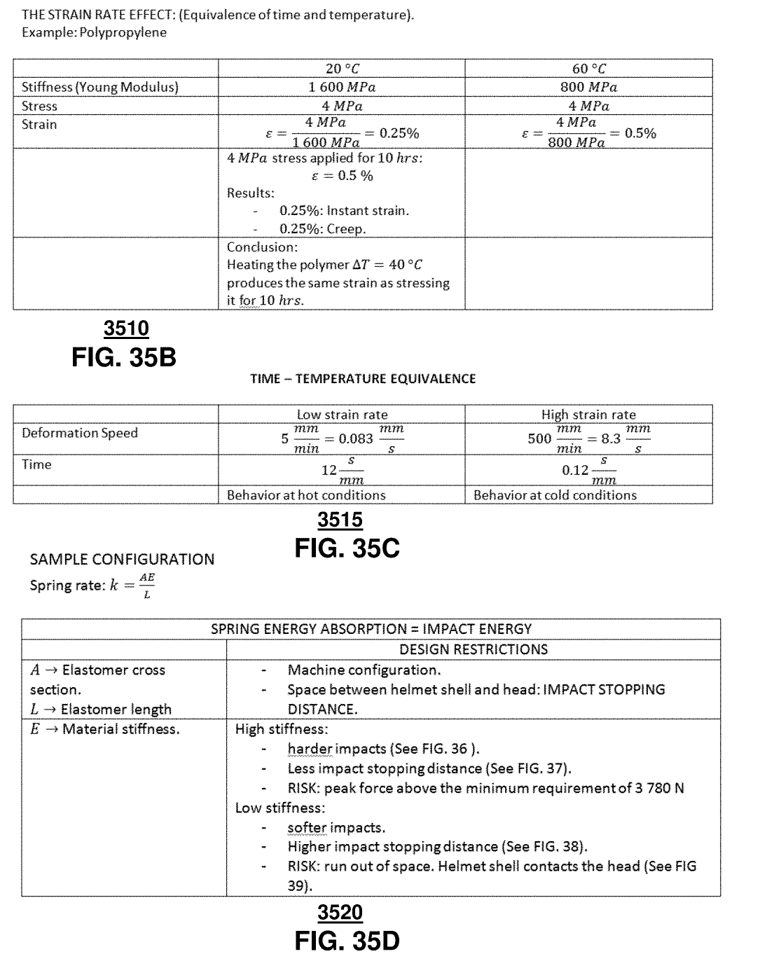

In operation, at least some separation of the levers 3404 may be allowed without inducing a plastic deformation of the safety strips 3412, e.g., sacrificial members 3412, e.g., allowing the sacrificial members 3412 to slide through their respective mounting slots 3413, without the enlarged end portions 3415 abutting ends of the mounting slots 3413. When ends of the safety strips abut their respective mounting slots 3413, the safety strips 3412 are subject to a strain. An illustrative stress-strain curve for a material, such as the material of the safety strips 3412, is provided and discussed below in reference to FIG. 35A.

In at least some embodiments, both the elastomeric loop 3420 and the safety strips 3412 act simultaneously. If the system provides a relatively soft, e.g., low stiffness response, through an impact event, allowing the head 3401 to travel with respect to the helmet shell 3402, an impact stopping distance, e.g., d₁, is reduced and/or lost altogether. According to such soft responsiveness, the shock abatement system 3400 would not able to sufficiently absorb the impact energy, allowing the helmet shell to contact the head 3401.

At a separation beyond a first separation threshold, one or more of the sacrificial members 3412 experiences a plastic deformation, e.g., according to the plastic region 3506, the plastic deformation can continue up to a second separation threshold, greater than the first, at which point one or more of the sacrificial members 3412 fractures, breaks and/or otherwise fails. In at least some operating temperature ranges, despite failure of the sacrificial members 3412, the elastomeric loop 3420 can remain operable beyond the second separation threshold. It is understood that one or more of plastic deformation and/or failure of the sacrificial member(s) 3412 and/or stretching of the elastomeric loop 3420 transfer kinetic energy of a collision into other forms of energy, thereby reducing another portion of the kinetic energy of the collision to a user of the helmet-style shock-abatement system. In at least some embodiments, selection of materials used and configurations are adapted, such that a limited amount of plastic deformation of the helmet shell 3402 occurs before, after or during operation of the lever assembly 3410. For example, one or more of a length, an overall shape, a cross section, a longitudinal cross-section profile, and the like, of a system component can be selected to promote operation of the system component in one or more of the elastic or the plastic regions under anticipated collision forces and/or operating temperatures. It is understood that such techniques can be applied to one or more of the different system components, such as the energy absorbing elements e.g., the elastomeric loop(s), the safety strip(s), to produce system components that have different elastic and/or the plastic response regions under anticipated collision forces and/or operating temperatures.

FIG. 34B depicts a more detailed view of the top portion of the lever-actuated helmet shock abatement system 3400′ of FIG. 34A. Each anchor of the pair of hooks 3414 is attached at one end to a top portion of the respective lever 3404. In at least some embodiments, one or more of the hooks 3414 are adapted to fail, e.g., including one or more geometric features that promote a mechanical disengagement of the hook and the loop under certain conditions, e.g., according to a predetermined force threshold. The anchors can be identical, similar or different in one or more of size, shape, attachment location, and the like. In the illustrative example, the hooks 3414 are similar, each having an elongated portion attached to the lever 3404 at a distal end. A proximal end of the hook is free, in that it is not attached to the lever 3404 and includes an enlarged feature to facilitate retaining or anchoring of the elastomeric member 3420. It is understood that in some embodiments, the anchor 3414 can be integrally formed with the lever, e.g., by molding, 3D printing, machining or the like. Alternatively or in addition, the anchor can be a separate member that is attachable to the lever. Any suitable means of attachment can be used, such as interference fit, snap fit, screw engagement, adhesives, welding, and so on. It is further understood that although the hooks 3414 is illustrated as being attached at one end and free at another end, some anchors can be attached at more than one location, e.g., forming a loop, a channel, an aperture, and the like.

Although the illustrative example includes two hooks 3414 for the two lever system 3400′, it is understood that a greater or fewer number of anchors can be provided. For example, one lever 3404 can be configured with an anchor having one or more of the various anchor properties disclosed herein. Another lever of the system can be configured without an anchor, per se, having the deformable loop attached in any suitable manner, e.g., including welding, adhesives, integrally formed as part of the lever, and so on. In any of the foregoing embodiments, separation of the levers 3404 results in separation of the pair of hooks 3414, which, in turn, stretches the elastomeric loop 3420. When a single hook 3414 is provided, separation of the levers results in a separation of the single hooks 3414 at one lever from another lever of the system between which the elastomeric loop 3420 is positioned.

FIG. 34C depicts a top perspective view of the lever-actuated helmet shock abatement system 3400″ of FIG. 34A during a second phase of operation that occurs during the course of an impact. During the second phase, the hook fails, fractures or breaks after a force applied by the loop 3420 reaches a force threshold. Upon breaking, the loop 3420 disengages the hook 3414. Namely, a force is applied to an outer surface of the helmet shell 3402. The force urges the helmet shell 3402 towards an opposing surface of the user's head 3401. The lever assembly 3410 is positioned between the helmet shell 3402 and the user's head 3401. In at least some instances, a separation distance d₂ between the top of the user's head 3401 and/or the top of the lever assembly 3410 is reduced from the pre-collision distance. Namely, d₂<d₁. Preferably, the separation distance d₂ offers advantages that also allow for a deformation of the helmet shell 3402, e.g., during the collision, without necessarily allowing any portion of the deformed helmet shell 3402 to touch the user's head 3401. It is understood that a threshold force at which the hook fractures or breaks can vary with temperature in a predetermined manner. Accordingly, a decoupling of the loop 3420 and the hook 3414 can be designed to occur during operation within a particular temperature range.

A head reaction force applied to the lever assembly 3410 induces a rotation or pivoting of the levers 3404 about their respective pivot joints 3406. In the example configuration, rotation of the levers 3404 results in an increased separation between top ends of the opposing levers 3404. In at least some embodiments, the increased lever separation distance pulls the ends of the first loop member 3420 into the hooks 3414. One or more of the anchors 3414 are adapted to fail under predetermined stress and/or strain conditions, e.g., at a certain force threshold, induced by a pulling action of the first loop member 3420. The hook 3414 can be adapted to mechanically fracture or fail, thereby disengaging the first loop member 3420 from the lever 3404. In at least some instances, the force causes one or both of the hooks 3414 to plastically deform. In at least some instances, the first loop member 3420 exerts a sufficient force on one or more of the hooks 3414 to plastically deform one or more of the hooks 3414 to a point of fracture.

FIG. 34D depicts a more detailed view of a top portion of the lever-actuated helmet shock abatement system 3400″ of FIG. 34C. The hook 3414 breaks after reaching a force threshold. The breakage disengages the first loop member 3420. The force threshold can vary with temperature, such that a decoupling of the first loop member 3420 from the lever 3404 can be designed for specific temperature conditions. Accordingly, the force threshold can be used to provide different system configurations at different temperatures. Consider a relatively warm temperature range at which the first loop member 3420 has primarily elastic properties. In such instances, a length of the first loop member 3420 can be stretched between the levers 3404 to a relatively large separation distance, without breaking. According to the elastic properties, the first loop member 3420 is adapted to absorb a substantial portion of a kinetic energy of the collision, converting it to potential energy stored in the stretched first loop member 3420. Consequently, a force, stress and/or strain on the hook 3414 is relatively low and below a threshold for plastic deformation and/or breakage of the anchor.

In some operating scenarios, the first loop member 3420, the first sacrificial member 3412a and the second sacrificial member 3412b contribute to the lever response of the system 3400. Operating scenarios can be determined at least in part by one or more of an operating temperature range, a magnitude and/or direction of an impact force. In other operating scenarios, only some, but not all of the first loop member 3420, the first sacrificial member 3412a and the second sacrificial member 3412b contribute to the lever response of the system 3400. Whether any of the first loop member 3420, the first sacrificial member 3412a and the second sacrificial member 3412b contribute to the lever response of the system 3400 can be predetermined, e.g., according to a design of the system. For example, dimensions, e.g., lengths, of one or more of the first loop member 3420, the first sacrificial member 3412a and the second sacrificial member 3412b can be determined or otherwise established to allow for selective engagement and/or selective disengagement with one or more of the levers 3404. For example, a length can be established to allow for slippage at a contact point between the sacrificial member 3412 and the lever 3404 allowing for an unconstrained rotation of the levers 3404 as the levers 3404 rotate over a first angular range. As the rotation continues beyond a threshold angle, one or more of the loop 3420 and/or members 3412 engage so as to prohibit further slippage. Alternatively or in addition, material properties are determined or otherwise selected to establish a predetermined range of a linear region 3502 and or non-linear region 3506 (FIG. 35) under the same and/or different operating temperature ranges.

It is understood that in at least some scenarios, e.g., in a relatively warm temperature range, the first loop member 3420 stretches sufficiently to allow the enlarged end portions 3415 of the second sacrificial members 3412 to engage their respective channels 3413. Accordingly, the first loop member 3420 and the sacrificial members 3412 can contribute simultaneously to the lever response. Depending upon the temperature range and force of the impact, the lever separation distance can increase to a point at which the second sacrificial members 3412 plastically deform and/or break, without experiencing deformation and/or breakage of the first loop member 3420 and/or the mounting hook 3414. Accordingly, the first loop member 3420 remains engaged, further contributing to the lever response, while the sacrificial member 3412 are disengaged. A similar response can be accomplished according to the various techniques disclosed herein, by having the first loop member 3420 disengage, while one or more of the sacrificial members 3412 remain engaged.

FIG. 34E depicts a top perspective view of the lever-actuated helmet shock abatement system 3400′″ of FIG. 34A during a third phase of operation, post disengagement of the first loop member 3420 from the lever 3404. It is further understood that one or more elements of the same system 3400″, e.g., the loop 3420, the sacrificial members 3412, the anchors 3414, the levers 3404, and the helmet shell 3402, exposed to a relatively cold temperature range can provide a significantly different individual responses. Beneficially, however, such individually different responses over extended temperature ranges can contribute to stability of an overall response of the shock abatement system 3400. Such configurations, material selections and the like, e.g., including selective disengagement of one or more of the first loop 3420 and the sacrificial member 3412, contribute to stability of the shock abatement system 3400 between cold conditions versus hot conditions. Namely, under cold conditions, the first loop member 3420 is less elastic. The first loop member 3420 and/or the hooks 3414 can fracture or break before the second sacrificial members 3412 plastically deform and/or break. Again, depending on the impact conditions, the second sacrificial members 3412 can continue to deform after the first loop member 3420 and/or hooks 3414 break to provide a multi-stage protection. Under cold conditions, the first loop member 3420, while engaging the hooks 3414, can provide a first stiffness profile, e.g., relatively stiff, relative to separation of the levers 3404. After the first loop member 3420 is disengaged from at least one of the levers 3404, the system 3400′″ provides a second stiffness profile, e.g., less stiff. Accordingly, the system offers less rigidity after disengagement of the first loop member 3420 from the hook 3414. The reduced rigidity can result in a further reduced separation distance between the helmet shell 3402 and the top of the user's head 3401. Namely, a separation distance d₃, such that d₃<d₂<d₁.

FIG. 35A depicts various characteristics of physical properties of a material 3500, such an illustrative stress-strain curve 3501. By way of general information, stress is related to deformation (strain). Likewise, a strength is related to stress. Resilience relates to an ability of a material to absorb energy when it is deformed and release that energy upon unloading. This can be referred to as an elastic region of the response. A toughness relates to an ability of a material to absorb energy and plastically deform without fracturing.

The example, e.g., ideal, stress-strain curve 3501 illustrates variations in stress according an applied strain. The curve 3501 includes a first region, referred to as an elastic region 3502 in which the stress is proportional to the strain. The elastic region 3502 exists from a non-stress state up until some maximum strain, e.g., a proportional limit 3504, beyond which the material undergoes a plastic deformation. The first region 3502 is sometimes referred to as a linear region 3502. The curve 3501 includes a second region, referred to as a plastic region 3506, extending from the proportional limit 3504 up until fracture 3508. The second region 3506 is sometimes referred to as a nonlinear region. This curve 3501 illustrates a general shape of a stress-strain response of a material, such as one or more of the materials used in a lever-actuated helmet shock abatement system 3400 disclosed herein. Also depicted are changes of a material under cold versus hot conditions. It is generally understood that the physical properties of a material can vary according to temperature. As the lever-actuated helmet shock abatement system 3400 can operate over a relatively large temperature range, changes of physical properties, e.g., the proportional limit 3504, the fracture 3508 are expected to change. One or more of the different configurations alone or on combination with selections of different materials are selected to provide a safety response, e.g., preventing the helmet shell 3402 from contacting a user's head 3401 directly, during an impact, collision, shock or blow, or more generally to divert at least a portion of an impact force and/or energy away from a protected body.

A proportional limit refers to a linear relation between stress and strain: σ=Eε. According to this relationship, the value σ refers to stress, e.g., a value measured in pressure units, such as MPa or psi. The value E refers to strain, e.g., a dimensionless value, and the value E refers to a material's stiffness, e.g., Young Modulus, also measured in pressure units, such as MPa or psi. A strain rate relates to a change in strain of a material with respect to time, e.g., deformation speed. A corresponding relationship can be determined as:

$$ɛ ( t ) [ \frac{1}{s} ]$$

Physical properties of a material can be characterized according to a glass transition temperature. It is generally understood that under relatively cold conditions, at least some materials, including materials of one or more components of the suspension system disclosed herein, can be characterized as being in a glassy state. Namely, the material(s) may be hard and relatively brittle when operated in a cold environment. Similarly, it is generally understood that under relatively warm or hot conditions, the same material(s), can be characterized as being in a viscous or rubbery state. Namely, the material(s) may be relatively soft and flexible when operated in a warm environment.

FIG. 35B depicts tabular information associated with a stress effect of a material. FIG. 35C depicts tabular information 3510 associated with a material behavior at high strain rates, as may be experienced during impact events. It should be understood that any of the tabular information disclosed herein is general in nature and not necessarily related to any component used in the example a lever-actuated helmet shock abatement systems. The time—temperature equivalence, relates material behavior at different temperatures to speed of deformation or strain rate. According to time—temperature equivalence, a sample material, polypropylene in this example, exhibits different properties at a relative low temperature, e.g., 20 deg. C. versus a relatively high temperature, e.g., 60 deg. C. In particular, the material exhibits a strain of 0.25% at 20 deg. C. versus a strain of 0.5% at 60 deg. C. It is understood that a material's physical response at relatively high deformation speeds (high strain rates) can simulate the material's response under cold operating conditions. Likewise, the material's physical response at relatively low deformation speeds can simulate the material's response under relatively hot operating conditions. It is generally understood that a mechanical response of polymers is time dependent. A creep phenomenon is due to a viscoelastic behavior of polymeric materials. It is also understood that in relation to spring energy absorption, kinetic energy of the collision is transformed into potential strain energy.

FIG. 35D depicts tabular information associated with physical properties 3520 of a sample configuration of a material used in a lever-actuated helmet shock abatement system according to the shock abatement assemblies 3400 illustrated in FIGS. 34A-34E, in which a spring rate of an elastomer, e.g., the first loop 3420, is determined according to a cross-sectional area, A, a length, L, and a material stiffness, E. Namely, the spring constant k=AE/L. Helmet systems including shock abatement assemblies 3400 can be tested using a common or test impact energy, e.g., applied to an external surface of the helmet shell 3402. Example tests include, without limitation, a force transmission test and/or an impact energy attenuation test. Such tests can measure a force resulting from the impact energy that is transmitted to a head 3401 of the user. At relatively cold operating conditions, due to material behavior, at least some materials become relatively stiff. Under relatively cold conditions, the system deforms over a shorter distance to absorb energy, because the system is more rigid. According to a response under cold conditions with the suspension system exhibiting a relatively rigid characteristic, the force transmitted to the user's head 3401 can be relatively high. At relatively warm or hot operating conditions, due to material behavior, at least some materials show an opposite behavior, e.g., becoming relatively less stiff. Under such relatively warm or less stiff conditions, the system uses a relatively greater distance to absorb energy, however, the force transmitted to the user's head 3401 is relatively low.

As an analogy, consider a bungee jump with a jumper attached to a metal, e.g., steel, cable verses an elastomer cable. With the steel cable (similar to cold conditions), a stopping distance of the jumper will be relatively short, as the metal cable stretches very little, and the jumper will suffer a substantially higher stopping force. With the elastomer cable (similar to hot conditions), the stopping distance of the jumper will be relatively long, as the elastomer stretches significantly more than the metal cable, and the stopping force the jumper will experience is smaller. Higher stiffness, e.g., greater rigidity during cold conditions, offers a lesser impact stopping distance, while a lower stiffness, e.g., lesser rigidity during warm conditions, offers a greater stopping distance under the same impact conditions. It is understood that design tradeoffs include available impact stopping distance—separation between helmet shell and user's head.

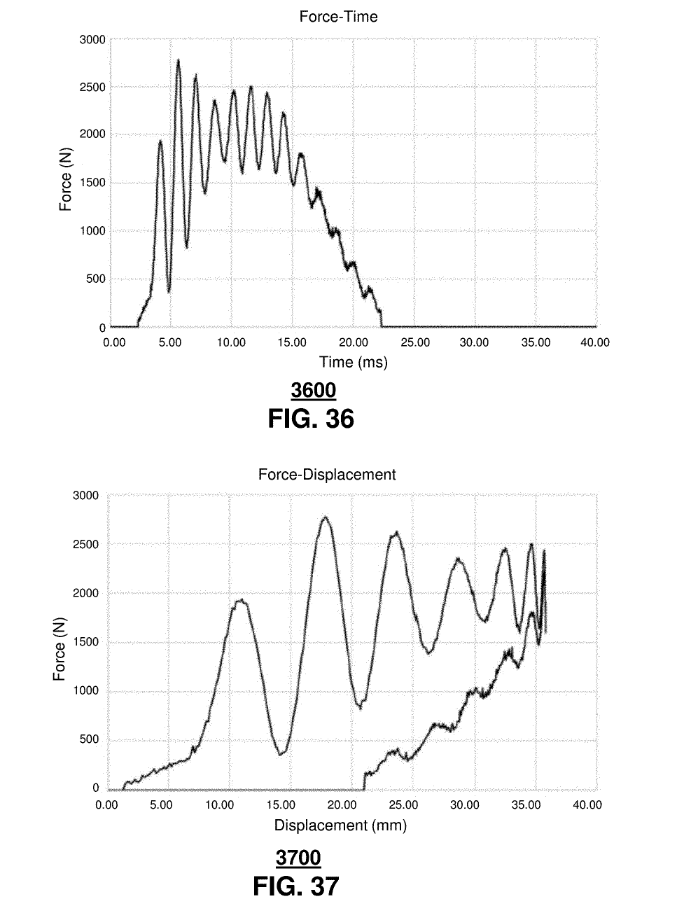

FIG. 36 depicts an example force versus time curve 3600 of a relatively high stiffness material used in a lever-actuated helmet shock abatement system.

FIG. 37 depicts an example force-displacement curve 3700 of the relatively high stiffness material of FIG. 36.

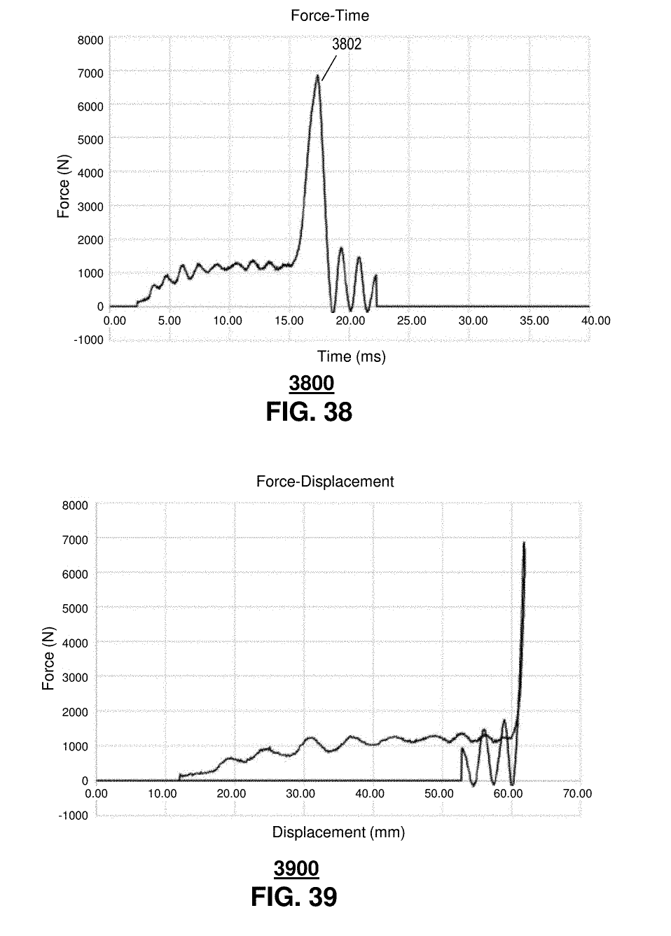

FIG. 38 depicts an example force-time curve 3800 of a relatively low stiffness material used in a lever-actuated helmet shock abatement system. At least one tradeoff with a relatively low-stiffness system is that an impact stopping distance, e.g., a distance d₁ between an interior surface of a helmet 3402 and an opposing surface of a user's head 3401 (FIG. 34A), can be consumed before all of the energy of a collision is absorbed by the suspension system. Consumption of the entire impact stopping distance before all of the energy of a collision is absorbed would result in an undesirable collision of the impact mass with a user's head 3401 (or a headform in a test configuration), thus producing a sudden peak force, e.g., peak force 3802.

FIG. 39 depicts an example force-displacement curve 3900 of the relatively low stiffness material of FIG. 38.

In some embodiments, the lever-actuated helmet shock abatement system takes advantage of a nonlinear spring response, e.g., operating in a nonlinear region of the stress-strain response curve 3500 (FIG. 35A). Materials of one or more of the components of a lever-actuated shock abatement system are combined according to their respective stress-strain behavior. Components selected according to their stress-strain performance can include, without limitation, one or more of anchors or hooks, safety loop, safety strip, the levers, the helmet shell. In at least some embodiments, materials are selected to provide a predetermined variability of their respective stress-strain response between different temperatures of an operational temperature range, which promotes stability of a safety response within a predetermined variability. In general, the safety response diverts at least a portion of one of the impact force, an impact energy of the collision or both away from the body of the user. Materials can include, without limitation, thermoplastic elastomers (TPE), polymers, composites, metals, non-ferrous metals, specialty alloys.

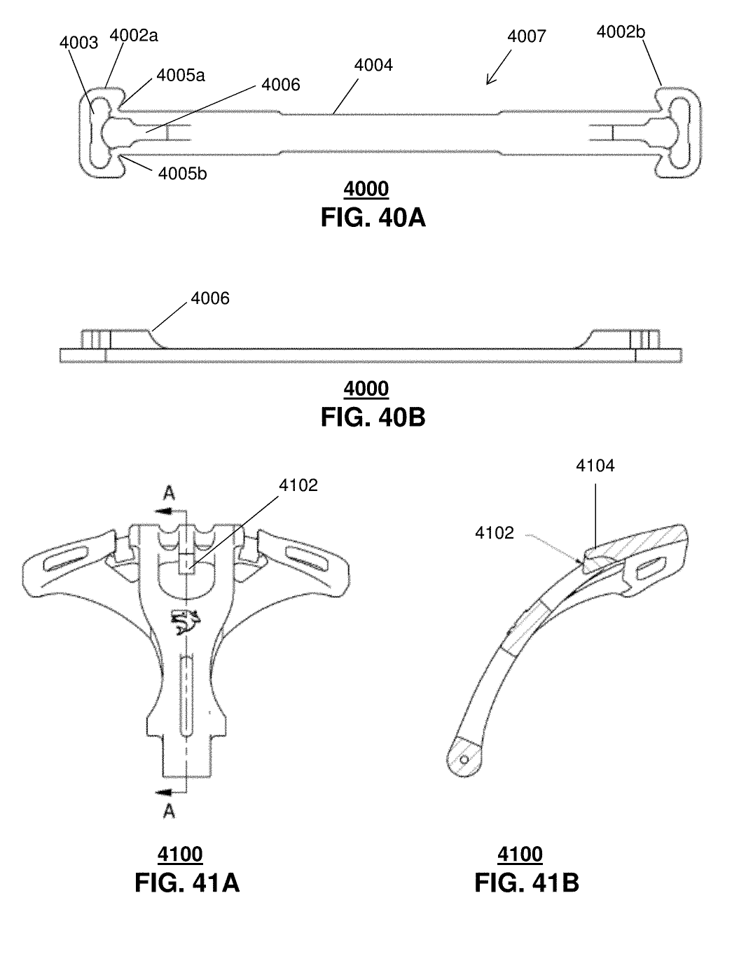

FIGS. 40A-40B depict top and side views of an embodiment of a breakable safety strip or band 4000. The safety strip 4000 can be positioned between the top ends of the opposing levers. In some embodiments, the safety strip 4000 is configured to be placed within the mounting slots 3413 between opposing levers 3404. The safety strip 4000 includes at least one relatively thin section adapted to yield, deform and/or otherwise fracture or fail by shear stress. Alternatively or in addition, the safety strip 4000 includes a pair of opposing ends 4002a, 4002b, generally 4002, having features adapted to yield, deform and/or otherwise fracture or fail according to shear stress. Each end 4002 of the illustrative example safety strip includes a loop 4003 defining an open interior region coupled or otherwise joined to an elongated strap portion 4007. The loop 4003 is joined to an end of the elongated strap portion at a pair of junctures 4005a, 4005b, generally 4005. (This can be contrasted to the safety straps 3412 illustrated in FIGS. 34A 34D, having solid heads, or end portions 3415).

A shear stress, e.g., induced by separation of the levers responsive to a collision, can cause one or both of the opposing ends 4002 to deform, e.g., whereby the loop 4003 folds or collapses inward. After the loop 4003 fractures, bends or collapses inwards, the safety strip 4000 can slip in its corresponding mounting slot 3412, thereby disengaging from the lever. In at least some embodiments, such deformation of the loop 4003 is accompanied by a hinged action or pivoting of one or more of the junctures 4005 allowing the loop 4003 to collapse sufficiently for the end 4002 to slide within its mounting slot or channel. Alternatively or in addition, the junctures 4005 can be sized and/or otherwise shaped to promote disengagement of one or both ends of the loop 4003 at the juncture(s) 4005 responsive to shear stresses resulting from a collision, once again, to allow the end 4002 to slide within its mounting slot or channel.

The illustrative example further includes at least one reinforced region 4006. The reinforced region 4006 is positioned at an end of the safety strip 4000, along a perimeter of the open region defined by at least a portion of the loop 4003. In the illustrative example, the reinforced region is adjacent to the junctures 4005. Namely, a portion of the reinforced region 4006 is positioned between a pair of junctures 4005a, 4005b. In operation, the reinforced region 4006 can promote a location at which plastic deformation and/or fracture occurs. According to the illustrative example, the reinforced region 4006 promotes a localization of a plastic deformation and/or fracture, such that deformation and/or fracture occurs, if at all, at one or more of the pair of junctures 4005a, 4005b.

In at least some embodiment, the open area defined by the loop 4003 can engage one or more hooks or anchors. Accordingly, the safety strip 4000 can be used as a loop structure between two or more anchors or hooks. It is understood that in at least some applications, the safety strip 4000 can be used as both a safety strip and an elastomeric loop.

The example safety strip 4000 is placed within the mounting slots 3413 of opposing levers 3404 with each end 4002 extending beyond an open end of a respective mounting slot 3413. Under some operating conditions the ends 4002 prevent the safety strip 4000 from sliding out of the slot, such that an increasing separation distance between the levers applies a strain to the safety strip 4000. As long as the safety strip 4000 is retained between the levers 3404, it can absorb at least a portion of an impact energy induced by a relative separation of the levers 3404. Under certain conditions, however, e.g., operating temperature and/or the applied stress, one or more of the loops 4003 can deform, e.g., collapse, allowing at least one end of the lever to slide through the respective mounting slot 3413. Once at least one end of the safety strip 4000 has slid through the respective mounting slot 3413, the safety strip does not absorb any further portion of the impact energy.

The example safety strip 4000 also includes an elongated portion or slim section 4004. In the illustrative embodiment the elongated portion 4004 extends between the pair of ends 4002. The safety strip 4000 can be formed of a homogeneous material having one or more regions configured to fracture during impact. For example, the loop 4002 can have a relatively thin profile, such that the loop fractures allowing it to disengage from at least one of the levers. Alternatively or in addition, the safety strip 4000 includes one or more regions, such as a slim section 4004, e.g., at a central region, having a relatively narrow or thin profile in comparison to other portions of the safety strip. When subjected to tension from an impact above a threshold value, the relatively narrow or thin profile region 4004 is adapted to fracture, again allowing it to effectively disengage from the levers.

FIGS. 41A-41B depict back and sectional views, respectively, of an embodiment of lever 4100 of a lever actuated helmet shock abatement system including an over-molded foam inclined plane. The lever 4100 includes an anchor or hook portion 4104 adapted to engage a safety strip 4000 (FIG. 40A-40B) and/or a first loop member 3420 (FIGS. 34A-34E). The anchor 4104 includes an inclined plane 4102 along its free end. The inclined plane 4102 is formed from a different material from the other portions of the anchor 4104. In particular, the different material is selected to exhibit different properties according to different operational temperature ranges. In some embodiments, the different material includes a urethane foam. In a relatively warm temperature range, the urethane foam deforms easily and promotes engagement of the safety strip 4000 or loop member 3420 (FIGS. 34A-34E). However, in a relatively cold temperature range, the urethane foam solidifies and functions as an inclined plane to promote disengagement of the safety strip 4000. Accordingly, the safety loop can selectively disengage from one or more of the levers during an impact, responsive to an operating temperature and without fracture.

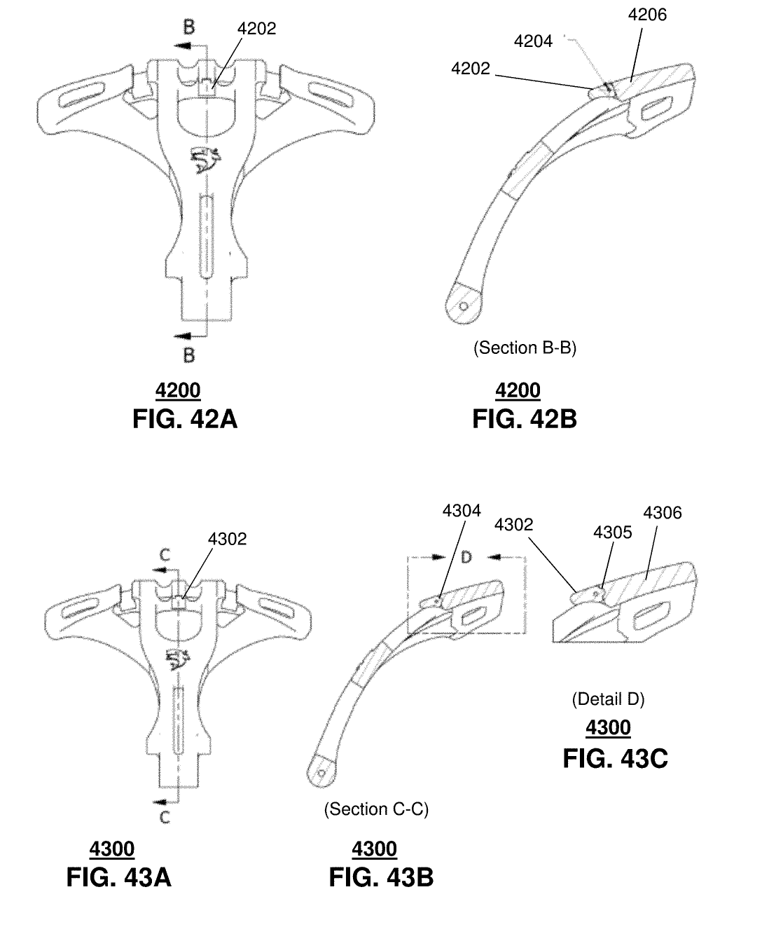

FIGS. 42A-42B depict back and sectional views, respectively, of another embodiment of a lever assembly 4200 of a lever actuated helmet shock abatement system, wherein the levers are adapted for selective disengagement. The lever assembly 4200 includes a pivoting anchor or hook 4202. The pivoting hook 4202 is assembled to a lever body 4206 via a rotary joint, such as an axle or shaft 4204. There exists an interference fit between the shaft 4204 and the lever body 4206 and between the shaft 4204 and the pivot hook 4202. Under pre-collision conditions, the pivot hook 4202 remains in a fixed or secure position with respect to the lever body 4206. According to the pre-collision configuration, the pivot hook 4202 is adapted or otherwise positioned to retain one or more of a first loop member 3420 (FIG. 34A-34E) or safety strip 4000 (FIGS. 40A-40B).

It is understood that during impact, separation of the upper portions of the levers 4200 stretches the first loop member 3420 and/or safety strip 4000 engaging more than one of the levers 4200. A reaction force of the elastomeric material of the loop 3420 and/or strip 4000 induced by the lever separation applies a force to the pivot hook 4202 that produces a torque. In at least some embodiments, a frictional engagement or interference fit between one or more of the shaft 4204 and the lever body 4206 and between the shaft 4204 and the pivot hook 4202 can be overcome when a torque above a threshold torque value is applied to the pivot hook 4202.

Working with one or more of an elastomer reaction force of the first loop member and/or safety strip and/or a size, shape and/or position of the lever arm, a torque produced during impact can be controlled or otherwise predetermined, such that the torque achieved during impact reaches the torque threshold value, thereby overcoming the interference fit friction force. Once overcome, the pivot hook 4202 rotates and/or twists about the shaft 4204. It is understood that in at least some embodiments, the rotation allows and/or otherwise induces a disengagement of the first loop member 3420 and/or safety strip 4000 from the pivot hook 4202. Such controlled disengagement of the first loop 3420 and/or safety strip 4000 can vary a stiffness of a response of the lever actuated shock abatement system. It is understood that the response can vary according to temperature as described herein, such that an impact under cold conditions produces a torque sufficient to rotate the pivot hook 4202 thereby releasing the loop and/or strip 3420, 4000, whereas, the same impact under warmer conditions may not reach the threshold torque.

FIGS. 43A-43C depict back, sectional and detail views, respectively, of yet another embodiment of a lever assembly 4300 of a lever actuated helmet shock abatement system, wherein the levers are adapted for selective disengagement. The lever assembly 4300 includes a snap-fit anchor or hook 4302. The snap-fit hook 4302 is assembled to a lever body 4306. The snap fit can be formed by a shaped, e.g., semispherical core 4304 and cavity 4305 adapted to accept the shaped core 4304 in an interference, snap-fit arrangement. Under pre-collision conditions, the snap-fit hook 4302 remains in a fixed or secure position with respect to the lever body 4306. According to the pre-collision configuration, the snap-fit hook 4302 is adapted or otherwise positioned to retain one or more of a first loop member 3420 (FIG. 34A-34E) or safety strip 4000 (FIGS. 40A-40B).

It is understood that during impact, separation of the upper portions of the levers 4200 stretches the first loop member 3420 and/or safety strip 4000 engaging more than one of the levers 4300. A reaction force of the elastomeric material of the loop 3420 and/or strip 4000 induced by the lever separation applies a force to the snap-fit hook 4302 that produces a force, e.g., a torque. In at least some embodiments, a frictional, snap-fit engagement or interference fit between one or more of the shaped core 4304 and the cavity 4305, e.g., formed in the lever body 4306 can be overcome when a force, e.g., a torque, above a threshold value is applied to the snap-fit hook 4302.

Working with one or more of an elastomer reaction force of the first loop member 3420 and/or safety strip 4000 and/or a size, shape and/or position of the lever arm 4302, a force, e.g., torque, produced during impact can be controlled or otherwise predetermined, such that the force achieved during impact reaches the threshold value, thereby overcoming the interference, snap-fit fit force. Once this force is overcome, the snap-fit hook 4302 is liberated and able to pivot about its axle 4204 from the cavity 4305. It is understood that in at least some embodiments, the pivoting or rotation of the snap-fit hook 4302 allows and/or otherwise induces a disengagement of the first loop member 3420 and/or safety strip 4000 from the lever body 4306. Such controlled disengagement of the first loop 3420 and/or safety strip 4000 can vary a stiffness response of the lever actuated shock abatement system. It is understood that the response can vary according to temperature as described herein, such that an impact under cold conditions produces a torque sufficient to separate the snap-fit hook 4302 thereby releasing the loop/strip 3420, 4000, whereas, the same impact under warmer conditions may not reach the threshold torque.

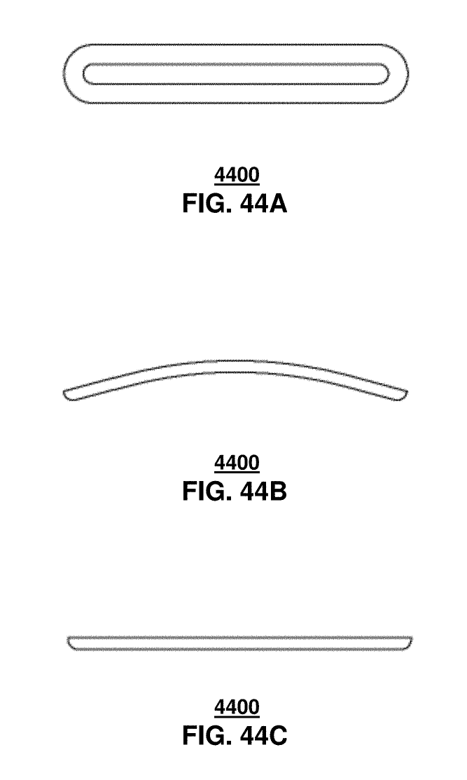

FIG. 44A depicts a top view of a shape memory safety band or loop 4400.

FIGS. 44B-44C depict side views of the safety loop 4400 of FIG. 44A according to first and second shapes. The safety band can be used as the first loop member 3420 (FIGS. 34A-34E). At least a portion of the safety loop 4400 can be formed from a shape memory material. Shape memory materials change their geometry when stimulated by an outside source. For example, an elastic loop can be designed to maintain a curved configuration in hot conditions, while becoming planar in cold conditions. A planar configuration can be adapted to disengage the elastomer from an anchor or hook of at least one of the levers.

In at least some embodiments, one or more deformable members, such as the example spring members and/or sacrificial members, can be placed between the levers and a protective shell. Accordingly, when the levers move, energy may be absorbed by deformation of the springs. More generally, the deformable members, e.g., spring members, do not have to be limited to contact foams and/or O-rings. More generally, any other kinds of spring can be used. Such springs, in operation, can cooperate with action of the levers. It is understood that such spring members alone or in combination can facilitate a “threshold strategy” in which a type of mechanical response of the protective system can differ based on a magnitude and/or acceleration of a collision.

The spring members, without limitation, can include a tension spring having one or more of a coil spring or an elastomeric material, e.g., such as an elastic band. Other embodiments can use any spring or rubber like material that can work under tension that can absorb energy by deformation in a different direction than that of the vector of the original impact. For example, extrusion can be used to create a cylindrical rubber band that is later cut, e.g., at a 45 degree angle in each of its ends, and glued together using an epoxy adhesive to form an enclosed ring of a predetermined size and shape.

One or more of the deformable members can remain in tension and/or slack with respect to any and/or all of the levers during normal periods of usage. Periods of use can be described generally as a static storage mode, a static use mode, and a dynamic impact mode. The static storage mode can include periods during which the helmet and/or shock abatement system is not placed on a portion of a body, e.g., during periods of non-use or storage. The static use mode can include periods during which the helmet and/or shock abatement system is placed on a portion of a body, e.g., during periods of usage or wear. The dynamic use mode can include periods during which the helmet and/or shock abatement system is placed on a portion of a body and exposed to external forces, such as exposed to during periods of impacts or collisions of the helmet with another object.

By way of example, in response to a vertically applied force, e.g., to a top portion of the helmet or head, the top portions of the levers generally rotate outward, away from the central axis. Such outward rotation of the top portions of the levers generally deforms the deformable member by stretching them. The stretching absorbs and/or otherwise stores kinetic energy of the lever rotation as potential energy by the expansion and/or compression of the resilient material, including plastic deformation up to failure of the sacrificial members. In at least some embodiments, upon a removal of the vertical force, the potential energy stored in at least some of the deformable member, e.g., the elastomers, can be transferred back to the levers to induce a rotation that returns the levers to a pre-stressed configuration.

In at least some embodiments, the shock abatement system can be configured with clasps, locks, catches, ratchet mechanisms or the like, to retain the levers in a rotated configuration, thereby preventing a transfer of potential energy stored in the top resilient member back to the levers. Although the illustrative examples include transformations of a kinetic energy associated with a collision into a potential energy, e.g., by deformation of a resilient material, such as a spring, it is understood that other energy absorbing and/or dissipating techniques can be used. For example, energy of a collision force can include transforming a kinetic energy to one of a potential energy, a mechanical energy, a thermal energy, an acoustic energy, an electrical energy, a magnetic energy, or any combination thereof.

In the example system, each of the levers is substantially aligned in a plane that contains the central axis. Rotation of each lever can be substantially confined to this plane in a manner that controls positions of the top and/or bottom attachments with respect to a user's head and/or neck. The pivot portions of the levers and/or the fulcra can be disposed in a plane perpendicular to the central axis. Separations of the top portions of the levers can be controlled by one or more of the sizes of the levers, positions of the pivots, size, shape and/or orientation of the pivot anchors, and/or characteristics, e.g., size, shape, resiliency of the deformable members.

The levers of the example shock abatement system are curved to provide a concave surface facing inward towards the central axis. For the example helmet application, the shock abatement system includes an open-ended interior region that is sized and/or otherwise shaped to accommodate at least a top portion of a user's head.

In the illustrative embodiments, the shock abatement systems can include an adjustment band that includes an occipital support with adjustment mechanism of the ratchet kind. However other embodiments can use any of the available adjustment mechanisms and/or occipital supports. Alternatively or in addition, the adjustment band can include one or more other components to facilitate fitting and/or securing the shock abatement system. Examples include, without limitation, a strap, belt or pad(s) that conforms to a portion of the object being protected, such as an adjustable strap that conforms to anatomical portion of the body, e.g., an adjustable nape or chin strap.

In some embodiments, a padding size, e.g., thickness, can be varied. Dimensions, shape and/or placement of the various pads used with the levers can be arranged to facilitate movement of the levers. Movement of the levers can include a first rotation in reaction to a downward force, and a second rotation in reaction to a side force. Accordingly, one or more of the lever arrays respond to impact forces from one or more directions.

In some instances the levers rotate “down” from the crown of the head toward the sides of the head. Alternatively or in addition the levers can rotate “up” from the side of the head to the crown of the head. The particular rotation, including a combination of down and up rotations, generally depends upon a direction and/or a location of the impact force or forces. By allowing the levers to rotate in more than one direction, the shock abatement system is able to react to one or more forces applied along one or more various directions.

It is understood that the shock abatement system 2000 can be placed within a protective shell, such as a helmet shell. Alternatively or in addition, the shock abatement system 2000 can be used without a separate protective shell. In the latter configuration, a collision force would be received directly upon an exterior facing surface of one or more of the levers 2004, 2014. In either configuration, one or more of the levers respond to the collision according to the various response disclosed herein. For example, one or more of the levers 2004, 2014 can pivot and/or flex in response to the collision force.

It is understood that virtually any material has an elastic region depending upon a magnitude of an applied force. Namely, an elastic deformation is a change in shape and/or size of a material induced by a relatively low stress that is recoverable after the stress is removed. A plastic region of deformation can be achieved in least some materials, by applying a relatively high stress, e.g., above or beyond the elastic region. It should be understood that such terms as used herein presume that the elastic regions of the materials fall within force ranges that allow the materials to be used for their elastic properties without causing damage or injury to a protected item, such as a human head.

Any of the deformable members disclosed herein can include a compressible element. The compressible element can include one of an elastic property, an inelastic property, or a combination of elastic and inelastic properties. It is understood that compressibility of the deformable member can result from one of a bulk material property, a geometry or shape, or a combination thereof. The compressible element can include any form of springs and/or shapes, such as corrugated shapes. In at least some embodiments, the compressible element can include a compressible material. Examples of compressible materials include, without limitation, one of a gas, a liquid, a solid, a gel, a foam, and combinations thereof, resilient materials, compliant materials. Alternatively or in addition, the deformable member can include a deformable system or assembly. Examples of deformable systems and/or assemblies can include airbag systems, and the like.

Beneficially, the various shock abatement systems disclosed herein facilitate mitigation of impact forces by one or more of deceleration, increasing a reaction distance and/or a extending a reaction time based on an impact force. In at least some embodiments, one or more of the deformable components, the mechanically actuated components contribute to a deceleration of a protective system in reaction to an impact, e.g., a collision force. Reaction distances can include one or more of relative distances between a protected item, e.g., a head, and a protective shell, e.g., a helmet. Alternatively or in addition, reaction distances can include one or more of distances traversed by one or more components of the shock abatement systems. For example, these distances can include displacements based on activation of mechanisms, such as the levers, the pulleys, the screws, the inclined planes, and the like. It is further understood that in at least some embodiments, any of the various configurations of the shock abatement systems disclosed herein can be contained entirely within and/or shielded entirely by the protective shell. Namely, the various shock abatement systems can be entirely housed within a helmet.

In at least some embodiments, no portion of a shock abatement system of a protective helmet system extends below a head portion and/or a neck portion of a body when the protective helmet system is work upon the head portion and/or the neck portion of the body. For example, none of the levers, the deformable members of the like, extend below the head and/or neck. It is understood that a lever assembly can be positioned entirely within an interior region of a protective shell. Alternatively or in addition, a portion of the lever assembly can be positioned within the interior region of the protective shell, while another portion of the lever assembly is not positioned within the interior region. In some embodiments, the entire lever assembly can be positioned external to a protective shell. Alternatively or in addition, the lever assembly can serve as a protective shell or cage, without necessarily requiring a separate shell.

The helmet system includes a machine that responds to a collision between an external surface of the helmet system and a foreign object, by providing a controlled movement that redistributes energy of the collision. The redistribution of the collision energy results in an absorption and/or dissipation of a non-trivial portion of the collision energy in one or more directions that differ from a direction of the collision, sometimes referred to as a line of impact. The machines can include, without restriction, any of the example arrangements of levers disclosed herein. In some embodiments, the helmet system includes an assembly of a protective shell and a lever system, arranged such that the protective shell forms at least a portion of the external surface of the helmet system exposed to the collision. Alternatively or in addition, the assembly of the protective shell and the lever system can be arranged such that the lever system forms at least a portion of the external surface of the helmet system exposed to the collision. In other embodiments, the helmet system includes a lever system that provides the entire exterior surface exposed to the collision. It is understood that in at least some embodiments, at least a portion of the lever system can serve as at least a portion of a protective shell. Examples of other shock abatement and/or impact protection systems are disclosed in one or more of U.S. Pat. No. 9,750,297, U.S. patent application Ser. Nos. 15/669,272 and 15/380,907, and Int'l Pat. App. No. PCT/IB2017/054850. The contents of each of the foregoing patents and patent applications are hereby incorporated by reference into this application as if set forth herein in full.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. The exemplary embodiments can include combinations of features and/or steps from multiple embodiments. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

Less than all of the steps or functions described with respect to the exemplary processes or methods can also be performed in one or more of the exemplary embodiments. Further, the use of numerical terms to describe a device, component, step or function, such as first, second, third, and so forth, is not intended to describe an order or function unless expressly stated so. The use of the terms first, second, third and so forth, is generally to distinguish between devices, components, steps or functions unless expressly stated otherwise. Additionally, one or more devices or components described with respect to the exemplary embodiments can facilitate one or more functions, where the facilitating (e.g., facilitating access or facilitating establishing a connection) can include less than every step needed to perform the function or can include all of the steps needed to perform the function.

The Abstract of the Disclosure is provided with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A safety device, comprising:
a shock abatement assembly adapted for placement between a protective shell and a body of a user, wherein the shock abatement assembly comprises:
a plurality of levers;
a plurality of fulcra that pivotally engage the plurality of levers, wherein at least one lever of the plurality of levers rotates about a respective fulcrum of the plurality of fulcra in response to an impact force of a collision between the protective shell and a foreign object to obtain a lever response; and
a sacrificial system including a first deformable member, wherein the sacrificial system is in communication with a group of levers of the plurality of levers,
wherein a first strain is applied to the first deformable member according to the lever response to obtain a first stress response of the first deformable member based on a first stress-strain relationship comprising a non-linear response,
wherein the first stress response of the first deformable member comprises the non-linear response, and
wherein the first stress response reduces a portion of the impact force transmitted to the body of the user.

2. The safety device of claim 1, wherein the first stress response comprises a plastic deformation of the first deformable member up to and including fracture.

3. The safety device of claim 1, wherein the sacrificial system further comprises a second deformable member,
wherein a second strain is applied to the second deformable member according to the lever response to obtain a second stress response based on a second stress-strain relationship comprising a linear response,
wherein the second stress response comprises the linear response of the second stress-strain relationship, and
wherein the second stress response reduces a portion of the impact force transmitted to the body of the user.

4. The safety device of claim 3, wherein the first deformable member comprises an anchor member, wherein the second deformable member is fixedly attached via the anchor member to a lever of the group of levers of the plurality of levers, wherein the first stress response comprises a plastic deformation of one of the first deformable member, the anchor member, or both.

5. The safety device of claim 3, wherein one of the first deformable member, the second deformable member or a combination thereof comprises an elastomer that stores energy in response to the lever response.

6. The safety device of claim 5, wherein the elastomer is fixedly attached between the group of levers of the plurality of levers, such that a rotation of a lever of the group of levers of the plurality of levers deforms the elastomer.

7. The safety device of claim 6, wherein the first stress response of the first deformable member comprising the non-linear response comprises one of a plastic deformation of the first deformable member, a fracture of the first deformable member, a disengagement of a portion of the sacrificial system from a lever of the plurality of levers, or a combination thereof.

8. The safety device of claim 7, wherein the second deformable member remains engaged between the group of levers of the plurality of levers through the first stress response of the first deformable member.

9. The safety device of claim 3, wherein the first stress-strain relationship and the second stress-strain relationship are determined according to an operating temperature of a predetermined range of operating temperatures, and wherein the first stress response and the second stress response facilitate a stability of a safety response of the shock abatement assembly within a predetermined variability that diverts at least a portion of one of the impact force, an impact energy of the collision or both away from the body of the user across the predetermined range of operating temperatures.

10. The safety device of claim 3, wherein the first deformable member absorbs a first portion of energy of the impact force of the collision according to the first stress response and wherein the second deformable member absorbs a second portion of energy of the impact force of the collision according to the second stress response.

11. The safety device of claim 3, wherein one of the first stress response, the second stress response, or both, dictates a selective disengagement of the sacrificial system from the lever of the plurality of levers.

12. The safety device of claim 1, wherein the protective shell is rigid in response to the impact force of the collision.

13. The safety device of claim 1, wherein the first deformable member includes one of a safety strip adapted to disengage the lever of the plurality of levers responsive to a plastic deformation of the safety strip up to and including fracture.

14. The safety device of claim 1, wherein the first deformable member is an anchor hook adapted to disengage a portion of the sacrificial system from the lever of the plurality of levers responsive to a plastic deformation of the anchor hook up to and including fracture.

15. The safety device of claim 1, wherein the first deformable member is a deformable hook comprising a compressible portion adapted to disengage a portion of the sacrificial system from the lever of the plurality of levers responsive to a thermally dependent stiffness of the compressible portion.

16. The safety device of claim 1, wherein the first deformable member is a hook comprising a snap fit portion adapted to disengage a portion of the sacrificial system from the lever of the plurality of levers responsive to a first stress occurring above a snap-fit actuation threshold.

17. The safety device of claim 1, wherein the first deformable member is a pivot hook that pivots about an axle, wherein an interference fit is formed between the pivot hook and the axle, and wherein the pivot hook is adapted to disengage a portion of the sacrificial system from the lever of the plurality of levers responsive to a first stress occurring above threshold stress to overcome the interference fit allowing the pivot hook to pivot about the axle.

18. The safety device of claim 1, further comprising an attachment device adapted to attach the shock abatement assembly to the protective shell.

19. A helmet suspension system, comprising:
a plurality of levers, wherein a first lever of the plurality of levers rotates about a fulcrum in response to an impact force of a collision between a helmet shell and a foreign object to obtain a lever response; and
a sacrificial assembly including a first deformable member, wherein the sacrificial assembly is in communication with a group of levers of the plurality of levers,
wherein a first strain is applied to the first deformable member according to the lever response to obtain a first stress response of the first deformable member based on a first stress-strain relationship comprising a non-linear response,
wherein the first stress response of the first deformable member comprises the non-linear response, and
wherein the first stress response reduces a portion of the impact force transmitted to a body of a user.

20. The helmet suspension system of claim 19, wherein the sacrificial assembly further comprises a second deformable member, wherein a second strain is applied to the second deformable member according to the lever response to obtain a second stress response based on a second stress-strain relationship comprising a linear response, wherein the second stress response comprises the linear response of the second stress-strain relationship, and wherein the second stress response reduces a portion of the impact force transmitted to the body of the user.

21. The helmet suspension system of claim 19, wherein the first stress response of the first deformable member comprising the non-linear response comprises one of a plastic deformation of the first deformable member, a fracture of the first deformable member, a disengagement of a portion of the sacrificial assembly from a lever of the plurality of levers, or a combination thereof.

22. A method for collision protection, comprising:
providing an impact protection assembly comprising a machine and a sacrificial assembly in communication with the machine, wherein the sacrificial assembly includes a deformable member;
receiving an impact force according to a collision between a protective shell and a foreign object, wherein the impact protection assembly is configured for attachment to the protective shell to facilitate protection of a body of a user from the impact force;
actuating the machine in response to the impact force of the collision; and
applying, by the actuating of the machine, a strain to the deformable member to obtain a stress response based on a stress-strain relationship comprising a non-linear response,
wherein the stress response of the deformable member comprises the non-linear response, and
wherein the stress response reduces a portion of the impact force transmitted to the body of the user.

23. The method for collision protection of claim 22, wherein the impact protection assembly provides a stable stiffness response across a range of operating temperatures due to selective disengagement of the deformable member.

24. The method for collision protection of claim 22, wherein the deformable member includes a safety strip, wherein the non-linear response comprises a plastic deformation of the safety strip up to and including fracture adapted to disengage a portion of the sacrificial assembly from the machine.

25. The method for collision protection of claim 22, wherein the deformable member is an anchor hook, wherein the non-linear response comprises a plastic deformation of the anchor hook up to and including fracture adapted to disengage a portion of the sacrificial assembly from the machine.

26. The method for collision protection of claim 22, wherein the deformable member is a deformable hook, wherein the non-linear response comprises compressing a compressible portion to obtain a compression of the deformable hook adapted to disengage a portion of the sacrificial assembly from the machine responsive to a thermally dependent stiffness of the compressible portion.

27. The method for collision protection of claim 22, wherein the deformable member is a hook including a snap-fit portion, wherein the non-linear response comprises a first stress occurring above a snap-fit actuation threshold facilitates actuation of the snap-fit portion to disengage a portion of the sacrificial assembly from the machine.

28. The method for collision protection of claim 22, wherein the deformable member is a pivot hook that pivots about an axle, wherein an interference fit is formed between the pivot hook and the axle, wherein the non-linear response comprises a first stress occurring above threshold stress to overcome the interference fit allowing the pivot hook to pivot about the axle to facilitate disengagement of a portion of the sacrificial assembly from the machine.
